(19) United States
(12) Patent Application Publication
(10) Pub. No.: US 2026/0201076 A1
(43) Pub. Date: Jul. 16, 2026

(54) CONJUGATES OF POLYSACCHARIDES AND HYDROPHOBIC COMPOUNDS AS EMULSION STABILIZERS

(71) Applicant: BASF SE, Ludwigshafen am Rhein (DE)

(72) Inventors: Claude TARANTA, Limburgerhof (DE); Pierre-Eric MILLARD, Ludwigshafen (DE); Laurent BILLON, Pau Cedex09 (FR); Vinay CHAUHAN, Pau Cedex09 (FR)

(21) Appl. No.: 19/133,599

(22) PCT Filed: Nov. 27, 2023
(86) PCT No.: PCT/EP2023/083111

§ 371 Date: May 28, 2025

(30) Foreign Application Priority Data
Nov. 28, 2022 (EP) 22209810.5

(51) Int. Cl. C08B 37/02; A01N 25/04; A01N 25/22; C08B 30/18; C08B 37/00

(52) U.S. Cl. CPC C08B 37/0021; A01N 25/04; A01N 25/22; C08B 30/18; C08B 37/0018

(57) ABSTRACT

The present invention relates to a conjugate of a saccharide compound, selected from di-, oligo- and polysaccharides, and at least one hydrophobic compound selected from terpenes, polyterpenes and polyterpene ethers,
where the hydrophobic compound in the conjugate is either directly bound to an oxygen atom of the saccharide or is present as a radical of the formulae (I) or (II):

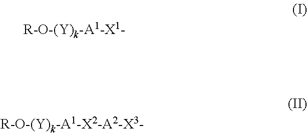

where in the formulae (I) and (II)
R is a radical of a terpene compound, a polyterpene or a polyterpene ether compound
k is 0 or 1,
Y is C(O) or C(O)NH,
A¹ is a direct bond or C₁-C₆ alkylene,
A² is C₂-C₁₀ alkylene,
X¹ is C(O), or may also be OC(O) or NHC(O) if k=1 and A¹ is C₁-C₆ alkylene and where X¹ is attached to an oxygen atom of the saccharide compound,
X² is C(O)NH or NHC(O)NH,
X³— is N═ or NH—,
and where X³ in formula (II) is attached to a carbon atom of the saccharide compound.

The invention also relates to the use of such a conjugate as a stabilizer for an aqueous emulsion of a water-immiscible liquid.

The present invention relates to the conjugates of polysaccharides and hydrophobic compounds and to their use as stabilizers for an aqueous emulsion of a water-immiscible liquid, in particular emulsions of a water-immiscible liquid, which contains an organic active, in particular an agrochemical compound or a cosmetic compound. The invention also relates to an aqueous composition of an organic active compound, in particular an agrochemical compound, which is an aqueous emulsion of a water-immiscible liquid containing the at least one organic active, where the aqueous emulsion contains at least one conjugate as defined herein.

### BACKGROUND OF THE INVENTION

Aqueous emulsions play a central role in numerous everyday processes, such as washing and cleaning processes, in the formulation and application of active ingredients in crop protection, pharmaceuticals and cosmetics, and in industrial processes, where aqueous emulsions are involved. Emulsions are known to be finely divided mixtures of an aqueous liquid and a liquid that is immiscible or only very slightly miscible with water, in which one of the two liquid phases is present as a disperse or internal phase that is distributed in the other phase. If the disperse phase is the aqueous phase, it is called a water-in-oil emulsion (w/o emulsion), whereas if the water-immiscible liquid forms the disperse phase, it is called an oil-in-water emulsion (o/w emulsion). Due to the high surface energy, emulsions are thermodynamically and kinetically unstable, with the disperse phase tending to coalesce into larger phases to reduce the surface energy. Surface-active substances are therefore used to stabilize aqueous emulsions.

Numerous active ingredient formulations are emulsions or form emulsions when diluted with water. For example, agricultural active compounds must be formulated in a manner that allows for a safe and efficient application of the agricultural active compound. For this purpose, the active compounds are often marketed in the form of concentrated formulations that are diluted in water during their application. Surfactants play a key role in such formulations. On one hand, they ensure problem-free dilution in water without creaming or sedimentation and uniform distribution in the aqueous phase and at the same time stabilize the active ingredients finely distributed in the aqueous dilution. Similar requirements must be met in pharmaceutical compositions.

In cosmetic and pharmaceutical formulations, such as creams and ointments, it is often necessary to co-formulate water insoluble liquids with an aqueous phase.

In detergents and cleaning agents, surfactants are needed to detach the dirt, especially grease and oily contaminants, from the soiled surface and stabilize it in the aqueous cleaning phase, e.g. the laundry suds or rinsing liquid.

Even though surfactants are indispensable for numerous applications, the problem arises that conventional surfactants affect the environment even when used as prescribed, since most of them degrade only slowly. There is therefore a fundamental need for surfactants that are readily degradable.

M-H. Alvès et al., Biomacromolecules 2014, 15, 242-251, describe amphiphilic polymers having a dextran backbone and thio-functionalized terpene groups attached to the backbone. The amphiphilic polymers can be used for preparing o/w miniemulsions. However, these amphiphilic polymers are difficult to prepare and limited to terpenes having free double bound. Their properties are not completely satisfactory and the polymers may produce toxic degradation products due to the presence of sulfur.

For several reasons, such as delayed release, toxicity, volatility, degradation or compatibility with other actives, organic actives may be formulated as a microcapsule formulation, e. g. as a microcapsule suspension. In such formulations, the organic active compound is provided in the form of particles, where the organic active compound or a solution of the organic active compound in a water-immiscible solvent is enclosed or embedded by a shell of a water-insoluble polymer (see H. Mollet, A. Grubenmann “Formulation Technology” 1^{st} ed., Wiley-VCH Verlag GmbH, Weinheim 2001, Chapter 6.4 and Chapter 14.2.2). Such polymers may be, for example, a polyurethane, polyurea, polyamide, polyester, polycarbonate, urea/formaldehyde resin, a melamine/formaldehyde resin, a polystyrene, or an acrylate polymer. Although microencapsulation of organic actives provides considerable benefits, as it reduces the acute toxicity and phytotoxicity of the organic active or reduces its volatility and degradation, it is often difficult to achieve. In particular, aggregation of the organic active during or after encapsulation is the main problem, if one encapsulation method, which may work for a particular organic active compound, does not necessarily work for another organic active compound. A further problem associated with microcapsule formulations is the considerable release of microplastics into the environment. In the environment, microplastics may accumulate in animals or plants and consequently end up in human nutrition (see e. g. C. M. Rochmann, “The global odyssee of plastic pollution, Science 368 (2020) pp 1184-1185). The use of synthetic polymer microcapsules is therefore increasingly meeting with ecological concerns on the part of customers and the regulatory authorities. Therefore, there is a demand for providing delivery forms for organic actives, which can be produced without non-degradable plastic material or with reduced amounts of non-degradable plastic material.

### SUMMARY OF THE INVENTION

It was now surprisingly found that the above mentioned problems are solved or at least ameliorated by conjugates of a saccharide compound, selected from di-, oligo- and polysaccharides and at least one hydrophobic compound selected from terpenes, polyterpenes and polyterpene ethers. When the conjugate is present in an aqueous emulsion, in particular an oil-in-water emulsions (hereinafter o/w emulsions) of a water-immiscible liquid, the stability of the emulsion is significantly improved and the emulsion may remain stable at least for weeks. Microscopic analysis of the emulsion indicate that the conjugate molecules aggregate on the phase boundaries and thereby form a stable layer, which surrounds the liquid droplets present in the aqueous emulsion, regardless of whether the emulsion is an oil-in-water (o/w) emulsion and the droplets are formed by the water immiscible liquid or the emulsion is an water-in-oil (w/o) emulsion and the droplets are formed by water which are emulsified in the non-aqueous liquid. The formation of a stable layer is observed regardless of whether the water-immiscible liquid contains a solid organic active, which is dissolved in a water-immiscible solvent.

The presence of the conjugate in the aqueous emulsion of the water-immiscible liquid stabilizes the droplets against coalescence and Ostwald's ripening and thus against phase separation. Moreover, conjugate molecules promote emulsification of the non-aqueous phase in the aqueous phase and vice versa.

Therefore, a first aspect of the invention relates to the conjugate as described herein. The conjugates are formed by a saccharide compound, selected from di-, oligo- and polysaccharides, and at least one hydrophobic compound selected from terpenes, polyterpenes and polyterpene ethers, which is directly, i. e. covalently bound, to an oxygen atom of the saccharide compound or is present as a radical of the formulae (I) or (II):

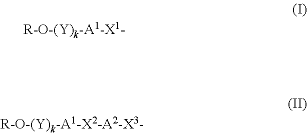

where in the formulae (I) and (II)
R is a radical of a terpene compound, a polyterpene or a polyterpene ether compound
k is 0 or 1,
Y is C(O) or C(O)NH,
A¹ is a direct bond or C₁-C₆ alkylene,
A² is C₂-C₁₀ alkylene,
X¹ is C(O), or may also be OC(O) or NHC(O) if k=1 and A¹ is C₁-C₆ alkylene X¹ and where X¹ is attached to an oxygen atom of the polysaccharide,
X² is C(O)NH or NHC(O)NH,
X³— is N═ or NH—,
and where X³ in formula (II) is attached to a carbon atom of the saccharide compound.

The conjugates of the present invention are particularly useful for stabilizing aqueous emulsions, in particular an oil-in-water emulsion, of a water-immiscible liquid.

Therefore, a second aspect of the present invention relate to the use of the conjugates of the present invention as stabilizers for aqueous emulsions, in particular an oil-in-water emulsions, of water-immiscible liquids and to a method for stabilizing an aqueous emulsion, in particular an oil-in-water emulsion, of a water-immiscible liquid, which comprises incorporating the conjugate of the saccharide compound and at least one hydrophobic compound as described herein into the aqueous emulsion of the water-immiscible liquid. Particular groups of embodiments of the second aspect of the invention relates to uses methods for stabilizing an o/w emulsion which contain at least one organic active compound, such as organic actives selected from agrochemicals, aromachemicals, pharmaceutically active compounds, vitamins, cosmetic actives and organic effect compounds

Yet, further aspects of the invention relate to
aqueous compositions, which is an aqueous emulsion of a water-immiscible liquid, which contains at least one conjugate of the present invention;
aqueous compositions of an organic active compound which is an aqueous emulsion of a water-immiscible liquid, which contains at least one conjugate of the present invention, where the water-immiscible liquid contains the organic active compound of the present invention;
a method for controlling plant pathogenic organisms, comprising the step of applying a pesticidally effective amount of said aqueous composition as defined herein and hereinafter,
washing and cleaning compositions containing the conjugate of the present invention.

The present invention is associated with several benefits. The conjugates as described herein promote the emulsification of the non-aqueous phase in the aqueous phase and stabilize the droplets of the emulsion against Ostwald's ripening and coalescence and thus against phase separation. Therefore, other emulsifiers usually required for the stabilization of the emulsion can be avoided or at least their amount can be reduced. Moreover, the conjugates of the present invention can be prepared in good yields by standard synthesis techniques of organic chemistry or polymer chemistry, respectively.

As mentioned above, the conjugate molecules aggregate at the interface between the aqueous phase and the non-aqueous phase of the emulsion and form a stable layer, which stabilizes the droplets against coalescence and thus against phase separation. In case of an o/w emulsion, the conjugate molecules form a stable layer surrounding the oil droplets present in the o/w emulsion, regardless of whether the water-immiscible liquid itself forms the oil-droplets or contains one or more organic active compounds such as pesticides dissolved in the water-immiscible solvent which form the droplets. In case of inverted emulsion, i. e. in case of a w/o emulsion, the conjugate molecules form a stable layer surrounding the aqueous droplets present in the w/o emulsion, which may contain a water-soluble pesticide dissolved in the aqueous phase. Therefore, the conjugate molecules mimic an encapsulation of the pesticide compound. For example, the presence of the conjugate in the aqueous emulsion of the pesticide compound will stabilize the emulsion droplets thereby increasing the stability of the emulsion. At the same time, they provide a good compatibility with other pesticides in aqueous emulsions.

Moreover, an improved selectivity of the pesticide against the target organism may be achieved by the conjugates. Since the conjugate molecules contain carbohydrate groups they will be biodegraded in the environment. Likewise, the terpenes, polyterpenes and polyterpene ethers, which are of biological origin, will biodegrade under environmental conditions. Therefore, the conjugates qualify as biodegradable surfactants. Moreover, it was found that the conjugates provide similar benefits as conventional microencapsulation. Therefore, they can replace conventional microcapsule materials and thereby reduce the input of microplastic into the environment.

### DETAILED DESCRIPTION OF THE INVENTION

The term “conjugate of a polysaccharide and at least one hydrophobic compound” is understood that the polysaccharide molecules bear at least one hydrophobic molecule, selected from terpenes, polyterpenes and polyterpene ethers, where the hydrophobic compound is either directly bound to the saccharide compound, i.e. covalently bound to a carbon or an oxygen atom of the saccharide compound by a covalent bond or it is bound by a covalent linker group, which, together with the hydrophobic compound forms a radical of the formulae (I) or (II), respectively.

Here and throughout this application the terms “organic active compound”, “organic active” and “active compound” are used synonymously. The terms are understood by the person skilled in the art to mean an organic chemical compound that triggers a physiological effect in living beings and plants, and substances that cause a chemical effect or catalyze a chemical reaction in inanimate nature. Examples of actives are aroma chemicals, organic crop protecting agents, organic pharmaceutical agents, organic cosmetic actives and organic actives for uses in the construction sector, called construction chemicals, especially catalysts for products in the construction sector, e.g. crosslinking or polymerization catalysts. The term “organic active” also includes “metal organic actives”.

Here and in the following, the term “water-immiscible” refers to a material, whose solubility in deionized water at 20° C. and 1 bar is at most 5 g/L, in particular at most 1 g/L. The solubility of the water-immiscible material in deionized water under the conditions given here may be zero, i. e. below the dection limit. Here and throughout the specification, the terms “the water-immiscible liquid” and “the water-immiscible organic liquid” are used synonymously.

The term liquid refers to a material in the liquid state at ambient conditions, i. e. to a non-solid and non-gaseous material. In the context of the invention, a liquid material preferably has a dynamic viscosity at 20° C. in the range of 0.2 to 2000 mPas, in particular in the range of 0.5 to 1000 mPas. Here and throughout the specification, ambient conditions refer to a temperature in the range of 20-25° C. and atmospheric pressure, i. e. about 1 bar.

The term “organic active compound of low molecular weight” refers to an organic or organometallic chemical active compound having a defined molecular weight Mn which is generally below 1000 daltons and typically in the range from 80 to <1000 daltons and especially in the range from 100 to 500 daltons. The molecular weight can be determined by mass spectroscopy.

The term “sensitive actives” refers to organic active compounds which are not stable to the conditions of their environment and are damaged or degrade, for example due to pH of their environment or by oxidation.

The terms “organic crop protecting agents”, “agrochemical”, “agrochemical compound”, “pesticide” and “pesticide compound” are used synonymously and refer to any physiologically active compound suitable for agricultural purposes. It means in particular compounds that are suitable for combating plant pathogenic organisms, such as harmful plants, volunteer plants, plant pathogenic fungi, plant pathogenic arthropods, such as plant pathogenic insects and arachnids, plant pathogenic nematodes, and mollusk. The term “agrochemical compound” thus include herbicides, fungicides, insecticides, nematicides and molluscicides. The term “agrochemical compound” also includes plant growth regulators, i. e. compounds which slow or reduce the growth of crop plants, and herbicide safeners, i. e. compounds which reduce the phytotoxic action of herbicides on crop plants.

With respect to the agrochemical compounds, the term “water insoluble or sparingly water-soluble” means that the agrochemical compound is insoluble in deionized water, i. e. its solubility is less than 0.1 g/L in deionized water, or it has a solubility of not more than 5 g/l or not more than 3 g/l, in particular not more than 2 g/l, e.g. from 0.1 to 5 g/l, in particular from 0. 1 mg/I to 3 g/l or from 0.1 mg/I to 2 g/l. The values given here refer to the solubility of the pesticide in deionized water as determined at 20° C. and 1 bar. In this context, the term “water-soluble” means that the pesticide is soluble in deionized water, i. e. its solubility is at least in deionized water is higher than 5 g/l, in particular at least 10 g/l, especially at least 20 g/l as determined at 20° C. and 1 bar. The water-soluble pesticide compound may also completely miscible with deionized water at 20° C. and 1 bar.

The term “alkyl” refers to a monovalent, linear or branched saturated hydrocarbon radical, which has e. g. 1 to 40 carbon atoms (C₁-C₄₀ alkyl), in particular 1 to 20 carbon atoms (C₁-C₂₀ alkyl), or 8 to 40 carbon atoms (C₈-C₄₀ alkyl), or 8 to 20 carbon atoms (C₈-C₂₀ alkyl) or 1 to 4 carbon atoms (C₁-C₄ alkyl). Examples of alkyl include but are not limited to methyl, ethyl, n-propyl, isopropyl, n-butyl, sec-butyl, isobutyl, tert-butyl, 2-methylpropyl (isopropyl), 1,1-dimethylethyl (tert-butyl), pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, n-heptyl, 2-heptyl, n-octyl, 2-octyl, 2-ethylhexyl, nonyl, isononyl, decyl, 3,7-dimethyloctane-1-yl, undecyl, dodecyl, tridecyl, isotridecyl, tetradecyl, pentadecyl, hexadecyl, heptadecyl, octadecyl, nonadecyl, eicosyl, heneicosyl docosyl and in case of nonyl, isononyl, decyl, undecyl, dodecyl, tridecyl, isotridecyl, tetradecyl, pentadecyl, hexadecyl, heptadecyl, octadecyl, nonadecyl, eicosyl, heneicosyl docosyl their isomers. Examples of C₁-C₄-alkyl are for example methyl, ethyl, propyl, 1-methylethyl, butyl, 1-methylpropyl, 2-methylpropyl or 1,1-dimethylethyl. The term “alkyl” also includes saturated hydrocarbon radicals resulting from the oligomerization of C₂-C₄ olefins such as ethylene, propene, 1-butene and isobutene. These radicals will usually have 6 to 40 carbon atoms and are a mixture of different isomers.

The term “alkylene” refers to a bivalent, linear or branched saturated hydrocarbon radical, which has e. g. 2 to 40 carbon atoms (C₂-C₄₀ alkylene), in particular 2 to 20 carbon atoms (C₂-C₂₀ alkylene), or 8 to 40 carbon atoms (C₈-C₄₀ alkylene), or 8 to 20 carbon atoms (C₈-C₂₀ alkylene) or 2 to 10 carbon atoms (C₂-C₁₀ alkylene). Examples of alkylene include but are not limited to 1,2-ethandiyl, 1,2- or 1,3-propandiyl, 1,4-butandiyl, 2-methylpropan-1,3-diyl, 1,1-dimethylethan-1,2-diyl, 1,5-pentandiyl, 1,6-hexandiyl, 2,2-dimethylpropan-1,3-diyl, 1,2-octandiyl, 1,8-octandiyl, 1,10-decandiyl, 3,7-dimethyloctane-1,7-diyl and 3,7-dimethyloctane-1,8-diyl.

The term “alkenyl” refers to a monovalent, linear or branched olefinically unsaturated hydrocarbon radical, which has e. g. 2 to 40 carbon atoms (C₂-C₄₀ alkenyl) in particular 2 to 20 carbon atoms (C₂-C₂₀ alkenyl), or 8 to 40 carbon atoms (C₈-C₄₀ alkyl), or 8 to 20 carbon atoms (C₈-C₂₀ alkenyl) or 2 to 4 carbon atoms (C₂-C₄ alkenyl) and which bear at least one, e. g. 1, 2 or 3 olefinically unsaturated double bonds. Examples of alkenyl include but are not limited to vinyl, allyl, butenyl, pentenyl, hexenyl, heptenyl, octenyl, nonenyl, decenyl, undecenyl, dodecenyl, tridecenyl, isotridecenyl, tetradecenyl, pentadecenyl, hexadeencyl, heptadecenyl, octadeencyl, nonadecenyl, eicosenyl, heneicosenyl docosenyl and in case of nonenyl, decenyl, undecenyl, dodecenyl, tridecenyl, isotridecenyl, tetradecenyl, pentadecenyl, hexadeencyl, heptadecenyl, octadeencyl, nonadecenyl, eicosenyl, heneicosenyl docosenyl, such as their isomers, e. g. the decenyl isomers 3,7-dimethyloct-6-ene-1-yl and 2,6-dimethyl-2,6-octadiene-8-yl.

The term “cycloalkyl” refers to a saturated cyclic hydrocarbon radical, which has e. g. 3 to 10 carbon atoms (C₃-C₁₀ cycloalkyl) or 5 to 8 carbon atoms (C₅-C₈ cycloalkyl). Examples of cycloalkyl include but are not limited to cyclopentyl, cyclohexyl, cycloheptyl, cyclooctyl, cyclododecyl and cyclohexadecyl.

The terms “bicycloalkyl” and “tricycloalkyl” refer to a saturated bicyclic and tricyclic hydrocarbon radical. “bicycloalkyl” has usually 6 to 12 carbon atoms (C₆-C₁₂ bicycloalkyl) while “tricycloalkyl” typically has 8 to 12 carbon atoms. Examples of bi and tricycloalkyl include but are not limited to norbornyl (=bicyclo[2.2.1]heptyl), isobornyl (=1,7,7-trimethylbicyclo[2.2.1]heptyl), decalinyl (=bicycle[4,4,0]decyl) and adamantyl (tricyclo[3.3.1.1^{3,7}]decyl).

Here and throughout the specification, the terms “wt.-%” and “% by weight” have the same meaning.

The “molecular weight Mn” or the “molar mass Mn” is the number-average molecular weight or molar mass. The “molecular weight Mw” or the “molar mass Mw” is the mass-average molecular weight or molar mass. If not stated otherwise, the Mn and Mw were determined by size exclusion chromatography (SEC) carried out by analogy to standard methods disclosed in the art using e.g. polyester copolymers as stationary phase, dimethylformamide+0.5% LiBr as eluent and polymethylmethacrylate standards (molar mass range 800-2200000 g/mol) by analogy to the method described by S. Chen et al., Polym. Chem., 2014, 5(18), 5310.

For lower molecular weights the number-average molecular weight can also be determined by ¹H NMR-spectroscopy.

The degree of substitution was determined by ¹H NMR spectroscopy from the amount of anomeric hydroxyl to methyl group in terpenes as described by M-H. Alves et al., loc. cit. The degree of substitution refers to the average number of hydrophobic compounds selected from terpenes, polyterpenes and polyterpene ethers with respect to the average number of saccharide repeating units of the polysaccharide compound.

The conjugate used according to the invention comprises a saccharide compound, which is selected from disaccharides, oligosaccharides and polysaccharides. Preferably the molecules of the conjugate comprise a single saccharide compound per molecule.

For the purpose of the invention, the term “disaccharide” is understood as a saccharide compound, wherein the molecules have two identical or different monosaccharide units that are connected by a glycosidic bond to form disaccharide molecules.

For the purpose of the invention, the term “oligosaccharide” and “polysaccharide” refers to saccharide compounds having on number average at least 3, e. g. 3 to 1000, in particular 3 to 500 identical or different monosaccharide units that are connected by glycosidic bonds to form linear or branched oligosaccharide or polysaccharide molecules. In this regard, the boundaries between oligo- and polysaccharides are not clearly defined. Typically, the term “oligosaccharide” refers to a saccharide compound, wherein the molecules have on average 3 to 10 identical or different monosaccharide units that are connected by glycosidic bonds to form linear or branched oligosaccharide molecules. Typically, the term “polysaccharide” is understood as a saccharide compound, wherein the molecules have on average more than 10, e. g. 10 to 1000 or 10 to 500 identical or different monosaccharide units which are connected by glycosidic bonds to form linear or branched polysaccharide molecules.

Preferably, the saccharide compound of the conjugate has a number average of 2 to 1000, in particular 5 to 1000, especially 10 to 500 monosaccharide repeating units. The number average of the monosaccharide repeating units relates to the molecular weight of the saccharide compound and, thus, it can be determined by size exclusion chromatography using a multi-angle scattered light detector as described e.g. by S. Lämmche et al. in “Characterisation of molecular parameters of dietary fibre components from pea and lupins with regard to their physico-chemical properties”, Doctoral Thesis, pp. 31-36, TU Berlin 2004. Alternatively, the number average molecular weight can be determined by osmometry as described by Y. Rong, M. Sillick and C M. Gregson in Journal of Food Science 2009, 74 (1), pp C33-040 (“Determination Of Dextrose Equivalent Value And Number Average Molecular Weight Of Maltodextrin By Osmometry”).

Suitable polysaccharides have a number average molecular weight (Mn) in the range of 1000 to 100000 dalton, in particular in the range of 1200 to 70000 dalton and especially in the range of 1300 to 50000 dalton and a weight average molecular weight (M_{W}) in the range from 1100 to 1500000 Dalton, in particular in the range from 1500 to 1000000 Dalton, especially in the range from 2000 to 500000 Dalton. The dispersity, i.e. the ratio of M_{W}/M_{N}, is usually in the range from 1.5 to 20, in particular in the range from 1.5 to 12. The molecular weights given here refer to the values as determined by size exclusion chromatography as described above.

Usually, suitable polysaccharides are characterized in that 2% by weight solution of its sodium salt in deionized water has a Brookfield viscosity in the range from 2 to 20000 mPas, in particular in the range from 5 to 10000 mPas, especially in the range from 10 to 5000 mPas. The viscosity values herein refer to the values determined by a Brookfield rotational viscometer according to DIN ISO 2555:2018-09 at 25° C. and rotational speed of 20 rotations per minute using spindle RV5.

In case of oligo- and polysaccharides, the saccharide molecules may be linear or branched.

The saccharide compounds may be composed of identical saccharide repeating units or different saccharide repeating units. The saccharide repeating units forming the saccharide compound are typically selected from non-ionic hexoses and non-ionic deoxyhexoses, such as glucose, mannose, rhamnose, arabinose and galactose and combinations thereof. The saccharide repeating units may, however, comprise anionic monosaccharide units, such as galacturonic acid, and/or basic monosaccharide units, such as glucosamine units or N-acetyl glucosamine units.

The saccharide compound is typically a non-ionic saccharide compound, selected from non-ionic disaccharides, non-ionic oligosaccharides and non-ionic polysaccharides. In particular the saccharide compound is a non-ionic di-, oligo or polysaccharide compound formed by aldohexoses, especially by glucose. In particular, the saccharide compound is selected from non-ionic oligo- or polysaccharides, especially non-ionic oligo- or polysaccharides formed by aldohexoses, especially by glucose.

Suitable oligosaccharides are in particular starch degradation products having an average number of glucose units in the range of 3 to 10 which corresponds to DE (dextrose equivalent) values in the range of 10 to 40. The DE is a measure of the amount of reducing sugars present in a sugar product, expressed as percentage on a dry basis relative to dextrose. Usually, the DE is determined in accordance to the method of Lane and Eynon and expressed as % inverted sugar or in accordance to the method of Luff-Schoorl and expressed in meq glucose/g. The respective methods are described in the Official Journal of the European Communities No. L/239/24-52 of 22 Sep. 1979 (79/78 6/EEC), methods 6 (Luff-Schoorl) and 7 or 8 (Lane Eynon).

In a preferred group of embodiments, the saccharide compound of the conjugate is an oligo- or polysaccharide compound having on average (number average) 5 to 1000 or 10 to 500 identical or different monosaccharide units which are connected by glycosidic bonds to form linear or branched polysaccharide molecules. The polysaccharide is in particular a glucan, i. e. a polysaccharide made of glucose units. In particular, the glucan is an α-glucan, which is in particular selected from the group of dextrans, pullulans, and starch degradation products (degraded starch), such as dextrins. Thus, the polysaccharide of the conjugate is a glucan, which is in particular selected from dextrans, pullulans, dextrins and combinations thereof. In a preferred group of embodiments, the polysaccharide of the conjugate is a dextran, i. e. a α-1,6-glucan with α-1,3-branches.

The conjugates of the invention comprise at least one a hydrophobic compound. According to the invention, the hydrophobic compound is a selected from terpenes, polyterpenes and polyterpene ethers. The hydrophobic compound may be either directly attached to an atom of the saccharide compound, e. g. a carbon or oxygen of the saccharide compound, by a covalent bond or by a bivalent linker group, or be present as a radical R which radical derived from terpene compound, a polyterpene or a polyterpene ether compound.

Thus, the conjugate molecules comprise at least one radical R, which is a radical of a terpene molecule, a polyterpene molecule or a polyterpene ether molecule.

The term “terpenyl radical” refers to radicals derived from terpenes, terpene alcohols and oxidized terpene alcohols, in particular from acyclic, monocyclic or bicyclic monoterpenes or sesquiterpenes or from monoterpene alcohols or sesquiterpene alcohols as described herein.

The term “polyterpene radical” refers to a radical of a polyterpene.

The term “polyterpene ether radical” refers to a radical of a polyterpene ether.

The term “terpene alcohol” refers to a terpene having an alcoholic OH (hydroxyl) group.

The terpenes may be hydrocarbon terpenes, terpene alcohols and oxidized terpene alcohols, in particular monoterpenes, sesquiterpenes, diterpenes, monoterpene alcohols (monoterpenols), sesquiterpene alcohols (sesquiterpenols), diterpene alcohols (diterpenols), oxidized monoterpene alcohols (oxidized monoterpenols), oxidized sesquiterpene alcohols (oxidized sesquiterpenols) or oxidized diterpene alcohols (oxidized diterpenols). In this context, the term terpene and terpene compound, respectively, refers to a hydrocarbon terpene compound. The term terpene alcohol refers to a terpene compound having a hydroxyl group, in particular a single hydroxyl group. The term oxidized terpene alcohol refers to a terpene alcohol, where the hydroxyl group has been converted into an aldehyde group, a keto group or a carboxyl group. Monoterpenes, monoterpene alcohols and oxidized monoterpene alcohols have 10 carbon atoms, sesquiterpenes, sesquiterpene alcohols and oxidized sesquiterpene alcohols have 15 carbon atoms and diterpenes, diterpene alcohols and oxidized diterpene alcohols have 20 carbon atoms, respectively. Preference is given to terpenes from the group of monoterpenes, monoterpene alcohols, oxidized monoterpene alcohols, sesquiterpenes, sesquiterpene alcohols and oxidized sesquiterpene alcohols.

The terpene compounds may be saturated or bear an olefinic double bond. They may be acyclic or alicyclic. Preferred terpene compounds are acyclic terpene compounds and alicyclic terpene compounds having a single 5- or 6-membered hydrocarbon monocycle or a single 6 to 9 membered hydrocarbon bicycle. Particularly preferred terpene compounds have 10 or 15 carbon atoms and are selected from acyclic terpene compounds and alicyclic terpene compounds having a single 5- or 6-membered hydrocarbon monocycle or a single 6 to 9 membered hydrocarbon bicycle.

Examples of acyclic terpene compounds include, but are not limited to citronellol, geraniol, nerol, linalool, myrcenol, lavandulol, ipsdienol, farnesol and nerolidol. Examples of cyclic terpene compounds include, but are not limited to menthol, terpineol, terpinen, pulegol, borneol and isoborneol.

In a particular group (0) of embodiments, the hydrophobic compound is selected from terpenol compounds, which are in particular selected from mono-, sesqui- and diterpenols, oxidized mono-, sesqui- and diterpenols, and polyterpene ether compounds, where the terpene units of the polyterpene ether compound is derived from mono-, sesqui- and diterpenols. In this particular group (0) of embodiments, the hydrophobic compound is in particular selected from monoterpenols, sesquiterpenols, oxidized monoterpinols and oxidized sesquiterpenols. In this particular group of embodiments, preferred terpenenol compounds and oxidized terpenol compounds are acyclic terpenol compound, oxidized terpenol compounds, alicyclic terpenol compounds and oxidized alicyclic terpenol compounds, where the alicyclic terpenol compounds and the alicyclic oxidized terpenol compounds have a single 5- or 6-membered hydrocarbon monocycle or a single 6 to 9 membered hydrocarbon bicycle. Particularly preferred terpenol compounds and oxidized terpenol compounds of this group (0) of embodiments have 10 or 15 carbon atoms and are selected from acyclic terpenol compounds, oxidized acyclic terpenol compounds, alicyclic terpenol compounds and oxidized alicyclic terpenol compounds, where the alicyclic terpenol compounds and the alicyclic oxidized terpenol compounds have a single 5- or 6-membered hydrocarbon monocycle or a single 6 to 9 membered hydrocarbon bicycle. In this particular group (0) of embodiments, the hydrophobic compound may also preferably be a polyterpene ether compound, which is derived from monoterpenols and sesquiterpenols, in particular from acyclic monoterpenols and acyclic sespquiterpenols.

In this group (0) of embodiments, the terpenol is especially selected from citronellol, geraniol, nerol, linalool, myrcenol, lavandulol, ipsdienol, farnesol, nerolidol, menthol, terpineol, pulegol, borneol and isoborneol, with particular preference given to citronellol, nerol, geraniol, myrcenol, pulegol, menthol and combinations thereof.

In this group (0) of embodiments, the polyterpene ether compound is in particular derived from citronellol, geraniol, nerol, linalool, myrcenol, lavandulol, ipsdienol, farnesol, nerolidol, menthol, terpineol, pulegol, borneol and isoborneol, with particular preference given to citronellol, nerol, geraniol, myrcenol and combinations thereof,

In a particular group (1) of embodiments, the radical R in formulae (I) and (II) is selected from terpenyl radicals, in particular from the group of monoterpenyl radicals and sesquiterpenyl radicals. In this context, it is clearly understood, that terpinyl radicals R is derived from a terpinol or oxidized terpinol of the formula R—OH. Thus, the term “derived from” is clearly understood that the moieties R and R—O, respectively, in formulae (I) and (II) stems from the terpinol or oxidized terpinol ROH. In this particular group (1) of embodiments, the radical R in formulae (I) and (II) is in particular derived from a monoterpenol or a sesquiterpenol, in particular from an acyclic mono- or sesquiterpenol or a alicyclic mono- or sesquiterpenol having a single 5- or 6-membered hydrocarbon monocycle or a single 6 to 9 membered hydrocarbon bicycle. In this group (1) of embodiments the radical R is in particular derived from citronellol, geraniol, nerol, linalool, myrcenol, lavandulol, ipsdienol, farnesol, nerolidol, menthol, terpineol, pulegol, borneol and isoborneol, with particular preference given to citronellol, nerol, geraniol, myrcenol, pulegol, menthol and combinations thereof.

In a special subgroup group (1a) of group (1) of embodiments, the radical R in formulae (I) and (II) is selected 3,7-dimethyloct-6-ene-1-yl, 3,7-dimethyloctane-1-yl, 2,6-dimethyl-2,6-octadiene-8-yl and 5-methyl-2-(propane-2-yl)-cyclohexane-1-yl.

In another group (2) of embodiments, the radical R in formulae (I) and (II) is a polyterpene ether radical, where the terpene units of the polyterpene ether have 10, 15 or 20 carbon atoms, in particular 10 or 15 carbon atoms and especially 10 carbon atoms. The polyterpene ether may have a terminal hydrogen atom or an alkyl or alkenyl radical, which has 8 to 20 carbon atoms. In group (2) of embodiments, preference is given to polyalkylene ether radicals which are derived from acyclic terpenes, especially from acyclic mono- and sesquiterpenes.

In particular, the terpene units in the polyterpenyl ether radicals are of the formula Alk:

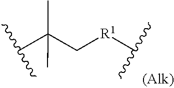

where R¹ represents a linear or branched alkylene radical having 6, 11 or 16 carbon atoms, in particular 6 or 11 carbon atoms and the zig zag lines indicate the points of attachment to the oxygen atoms of the polyalkylene ether.

In particular, the polyterpenyl ether radicals, are of the formula PAE:

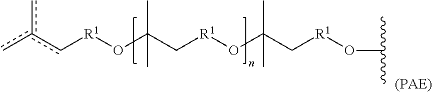

where R¹ represents a linear or branched alkylene radical having 6, 11 or 16 carbon atoms, in particular 6 or 11 carbon atoms, n is an integer from 0 to 20, in particular 0 to 10 and especially 0 to 4 and the zig zag lines indicate the points of attachment to a linker or to a carbon atom of the saccharide.

In the groups (1), (1a) and (2) of embodiments, the preferences given for the saccharide compounds apply in the same way. In particular, the saccharide compounds are selected from di-, oligo and polysaccharide compounds, wherein the polysaccharide is a α-glucan, such as dextrans, amyloses, pullulans, starches and starch degradation products, such as dextrins. In the groups (1), (1a) and (2) of embodiments, the saccharide is especially a dextran.

The weight ratio of the radicals R to the polysaccharide in the non-ionic conjugate is frequently in the range of 20:1 to 1:80. If the polysaccharide is used as a stabilizer for o/w emulsions the weight ratio of the radicals R to the polysaccharide in the non-ionic conjugate is preferably in the range of 1:1.5 to 1:80, in particular in the range of 1:2 to 1:60.

In the conjugate of the present invention, in particular in the groups (1) and (1a) of embodiments, the saccharide compound is substituted by at least one hydrobic compound, which is selected from terpenes, polyterpenes and polyterpene ethers.

In the saccharide compound of the conjugate may bear a single hydrophobic compound or has a degree of substitution with the hydrophobic compound or the group R, respectively, in the range of up to 300 mol-%, in particular in the range of 1 to 200 mol-% and especially in the range of 1 to 100 mol-% with respect to the monosaccharide units of the saccharide compound. If the conjugate of the present invention is used in o/w emulsions, the saccharide of the conjugate has preferably a degree of substitution in the range of 1 to 100 mol-%, in particular in the range of 5 to 100 mol-%, especially in the range of 5 to 60 mol-% with respect to the monosaccharide units of the saccharide.

The radicals R may be directly covalently bound to one atom, e. g. an oxygen atom, of the saccharide or may be covalently bound to the saccharide by a linker, depending on the way how the conjugate is produced. Typically, the linker has 1 or 2 functional groups such as carbonyl groups, carboxyl groups, carbamide groups or urethane groups or secondary amino groups or imine groups, wherein one group stems from the reaction of the hydrophobic compound with the carbohydrate and while an optional second group may stem from the functionalization or activation of the hydrophobic compound.

In particular groups (3) and (4) of embodiments of the invention, the terpene compounds are present in the conjugate molecules in the form of the groups of either the formula (I) (group 3) or the formula (II) (group 4):

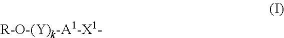

where in formula (I) the variables R, k, Y, A¹, X¹ are as defined herein, and where
R is in particular a terpenyl radical radical;
k is 0 or 1, in particular 1;
Y is C(O) or C(O)NH, in particular C(O);
A¹ is a direct bond or alkylene having 1 to 6 carbon atoms (C₁-C₆ alkylene), and where A¹ is in particular C₂-C₆ alkylene;
X¹ is C(O), or may also be OC(O) or NHC(O), where X¹ is in particular C(O) if k=1 and A¹ is C₂-C₆ alkylene and
   where X¹ is attached to an oxygen atom of the saccharide compound, in particular to an oxygen atom of a polysaccharide;

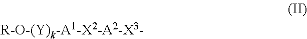

where in formula (II) the variables R, k, Y, A¹, A², X² and X³ are as defined herein, and where
R is in particular a terpenyl radical, a polyterpene radical or a polyterpenyl ether radical,
k is 0 or 1, in particular 1
Y is C(O) or C(O)NH, in particular C(O)
A¹ is a direct bond or alkylene having 1 to 6 carbon atoms (C₁-C₆ alkylene) and where A¹ is in particular C₂-C₆ alkylene,
X² is C(O)NH or NHC(O)NH, in particular C(O)NH,
A² is alkylene having 2 to 10 carbon atoms (C₂-C₁₀ alkylene), in particular C₂-C₁₀alkylene where 1, 2 or 3 non-adjacent carbon atoms of alkylene may be replaced by oxygen atoms,
X³— is N═ or NH—, i. e. an imino or amino nitrogen,
   and where X³ is attached to a carbon atom of the saccharide compound, in particular to a carbon atom of a polysaccharide.

Particularly preferred are the conjugates of group (3) of embodiments,

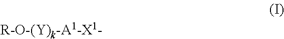

where in formula (I) the variables R, k, Y, A¹, X¹ are as defined herein, and where
R is in particular a terpenyl radical radical;
k is in particular 1;
Y is C(O);
A¹ is in particular C₂-C₆ alkylene;
X¹ is C(O).

In the groups (3) and (4) of embodiments the radical R is preferably according to the groups (1), (1a) and (2) of embodiments. In the groups (3) and (4) of embodiments the preferences given for the saccharides apply in the same way. In particular, the polysaccharide is preferred, which is an α-glucan, such as dextrans, amyloses, pullulans, starches and starch degradation products, such as dextrines. In the groups (3) and (4) of embodiments, the saccharide is especially a dextran.

In particular, the saccharide of the conjugate of groups (3) and (4) of embodiments have a degree of substitution with the radicals of the formulae (I) or (II) in the range of 1 to 300 mol-%, in particular in the range of 5 to 200 mol-% with respect to the monosaccharide units of the saccharide. If the conjugate of groups (3) and (4) of embodiments is used in o/w emulsions, the saccharide of the conjugate has preferably a degree of substitution with the radicals of the formulae (I) or (II) in the range of 1 to 100 mol-%, in particular in the range of 5 to 100 mol-%, especially in the range of 5 to 60 mol-% with respect to the monosaccharide units of the saccharide.

According to group (5) of embodiments, the conjugate is a graft copolymer of the polysaccharide. In this graft copolymer, the polysaccharide forms the backbone to hydrophobic compounds are attached directly or via a linker to the monosaccharide repeating units of the polysaccharide backbone, i. e. the radical R is present as a group of the formulae (I) or (II), respectively. The graft copolymer generally has a degree of substitution with the hydrophobic compound or the groups (1) or (11), respectively, in the range of 1 to 300 mol-%, in particular in the range of 5 to 200 mol-% especially in the range of 10 to 200 mol-% with respect to the monosaccharide units of the polysaccharide. If the conjugate of the group (5) of embodiments is used in o/w emulsions, the saccharide of the conjugate has preferably a degree of substitution in the range of 1 to 100 mol-%, in particular in the range of 5 to 100 mol-%, especially in the range of 5 to 60 mol-% with respect to the monosaccharide units of the saccharide.

In the group (5) of embodiments the radical R is preferably according to the groups (1), (1a) and (2) of embodiments. In particular, the radical R is a terpenyl radical or polyterpenyl ether radical. In the group (5) of embodiments the radical R is preferably present as a radical of the formula (I) as defined in group (3) of embodiments. In the group (5) of embodiments, the preferences given for the polysaccharides apply in the same way. In particular, the polysaccharide is an α-glucan, such as dextrans, pullulans, and starch degradation products, such as dextrins. In the group (5) of embodiments, the polysaccharide is especially a dextran.

According to another group (6) of embodiments, the conjugate is a block copolymer. Such a block copolymer comprises a polysaccharide block and at least one block formed by the hydrophobic compound or compounds, which are attached to at least one of the terminal saccharide units of the polysaccharide block. If the polysaccharide is linear, it has 1 or 2 hydrophobic compounds attached to its termini.

In the group (6) of embodiments the radical R is preferably according to the groups (1), (1a) and (2) of embodiments. In particular, the radical R is a polyterpenyl ether radical. In the group 5 of embodiments, the radical R is preferably present as a radical of the formula (II) as defined in group (4) of embodiments. In the group (6) of embodiments, the preferences given for the polysaccharides apply in the same way. In particular, the polysaccharide is an α-glucan, such as dextrans, pullulans, starches and starch degradation products, such as dextrins. In the group (6) of embodiments, the polysaccharide is especially a dextran.

The weight ratio of the hydrophobic compound to the saccharide compound in the conjugate is in the range of 3:1 to 1:80, in particular in the range of 2:1 to 1:60.

In one particularly preferred group (7) of embodiments, the hydrophobic compound in the conjugate is either directly bound to an oxygen atom of the saccharide or is present as a radical of the formulae (I). If the hydrophobic compound in the conjugate is directly bound to an oxygen atom of the saccharide compound, the hydrophobic compound is preferably an oxidized terpenol, which bears a carboxyl group, which forms an ester group with an oxygen atom of the saccharide compound.

In another particularly preferred group (8) of embodiments, the hydrophobic compound is present as a radical of the formulae (II). In this group, R in the formulae (II) is especially a polyterpene ether radical.

The conjugates of the present invention can be prepared by analogy to known methods for producing conjugates of saccharides and hydrophobic organic compounds as described e. g. in CN112390834, JP-H 03292301, JP 61069801 A, L. Billon et al. Biomacromolecules (2014), 15(1), 242-251, S. Otto et al. Carbohydrate Polymers 254 (2021) 117280, A. Durand et al. Langmuir (2004), 20, 6956-6963, Save et al. Biomacromolecules (2022), 23, 2536-2551.

For example, a compound of the formula (III)

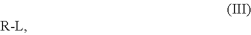

where R is as defined herein and L is a leaving group, such as bromine, iodine, C₁-C₄-alkyl sulfonate or tolyl sulfononate, is reacted with the saccharide, typically in the presence of a basic catalyst, whereby the radical R is covalently bound to an oxygen atom of the saccharide.

It is also possible to start from a compound of the formula (IV)

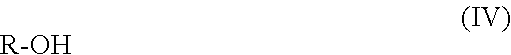

where R is as defined herein. In the compound (IV) the OH group is either activated to form a leaving group or coupled with a compound that has a further functionality which is capable of forming a covalent bond with one of the OH groups of the saccharide or another reactive group previously introduced into the saccharide.

For example, the compound of the formula (IV) can be converted into a reactive ester, such as a chloroformate ester or a carbonate of the formulae (IVa) or (IVb), which is capable to react with an OH group of the saccharide.

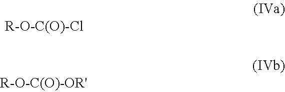

In the compounds of the formulae (IVa) and (IVb), the radical R is as defined herein and the radical R′ in formula (IVb) is C₁-C₄-alkyl, such as methyl or ethyl, or hydrogen.

In a particular preferred group of embodiments, the compound (IV) is converted into a compound of the formula (V),

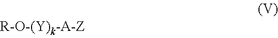

where
R is as defined herein,
k is 0 or 1, in particular 1
Y is C(O) or C(O)NH, in particular C(O)
A is a direct bond or a bivalent hydrocarbon radical, in particular alkylene, having 1 to 6 carbon atoms,
Z is either an isocyanate group, a COOH group or an activated carboxyl group, such as a reactive ester group, e. g. a group COOR′, or an anhydride group.

For example, the compound of the formula (IV) may be reacted with an aliphatic dicarboxylic acid having 2 to 8 carbon atoms, or a di-C₁-C₄-alkyl ester thereof under conditions of an esterification to obtain a compound of the formula (V), where k=1, Y═C(O) and Z═COOH or C(O)—O—C₁-C₄-alkyl. Suitable dicarboxylic acids include e. g. oxalic acid, malonic acid, succinic acid, glutaric acid, adipic acid, suberic acid and pimelic acid.

Alternatively, the compound of the formula (IV) may be reacted with an aliphatic diisocyanate having 3 to 8 carbon atoms under urethane forming reaction conditions to obtain a compound of the formula (V), where A is alkylene, having 1 to 6 carbon atoms, k=1, Y═C(O)NH and Z═N═C═O, e. g. under the conditions described in JP-H 03292301. Suitable diisocyanates include e. g. methane diisocyanate ethane diisocyanate, propane diisocyanate, butane diisocyanate, pentane diisocyanate and hexane diisocyanate.

The compound of the formula (IV) may be reacted with a compound of the formula (VI)

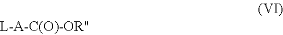

where L is a leaving group, such as Br or I, A is alkylene, having 1 to 6 carbon atoms and R″ is H or C₁-C₄-alkyl.

Apparently, the thus obtained compounds of the formulae (IVa), (IVb) and (V) bear a functional group which is reactive to the OH groups of the saccharide and thus can be coupled with the saccharide under suitable reaction conditions described in the prior art or in the examples of the present application. Thereby, conjugates of the saccharide and the compounds of the formulae (IVa), (IVb) and (V) are obtained. In a preferred group of embodiments, these conjugates are in a form of a graft polymer, where some of the OH groups of a polysaccaharide compound are replaced by groups bearing a radical R, e. g. a group of the formula (I).

It is also possible to activate the saccharide by introducing one or more reactive groups, which are capable of reacting with a suitable compound bearing the radical R. For example, the saccharide may be reacted with a diamino compound having two primary amino groups, in particular a C₂-C₁₀ alkylene diamine of the formula H₂N-A′-NH₂, where A′ is C₂-C₁₀ alkylene where 1, 2 or 3 non-adjacent carbon atoms of C₂-C₁₀ alkylene may be replaced by oxygen atoms. Thereby, the aldehydic carbon atom of the terminal saccharide moiety is converted into an imine, which is then hydrogenated to obtain a saccharide, which bears an aminoalkyl amino group at the terminal saccharide moiety. The primary amino group of the aminoalkylamine group may be reacted with a compound of the formulae (IVa), (IVb) or (V) whereby a conjugate is obtained, where the terminal saccharide unit carries a radical R in the form of a group of formula (II).

Conjugates of the preferred group (3) of embodiments, where X¹ is C(O) are in particular prepared by reacting a saccharide compound with a compound of the formula (V), where Z is COOH in the presence of an enzyme which is capable of catalyzing an esterification reaction, such as a lipase, in particular an immobilized lipase. Likewise, conjugates can be prepared, where an oxidized terpenol compound bearing a carboxyl group is attached directly to saccharide compound. Conjugates of the preferred group (4) of embodiments, where X² is C(O)NH can be prepared by reacting a saccharide compound bearing at least one group NH₂-A²-X³— with a compound of the formula (V), where Z is COOH in the presence of an enzyme which is capable of catalyzing an amidation reaction, such as a lipase, in particular an immobilized lipase. Likewise, conjugates can be prepared, where an oxidized terpenol compound bearing a carboxyl group is attached directly to saccharide compound. These processes have not yet been described in the art and thus are part of the present invention.

Therefore, the invention also relates to a process comprising reacting a saccharide compound or a saccharide compound bearing at least one group NH₂-A²-X³— with a compound of the formula (V), where Z is COOH or with an oxidized terpene alcohol bearing a carboxyl group, in the presence of an enzyme which is capable of catalyzing an esterification or amidation reaction, such as a lipase, in particular an immobilized lipase.

Preferably, the saccharide compound used in the process of the invention is a polysaccharide compound, which optionally bears at least one group NH₂-A²-X³—. In particular, the polysaccharide compound is selected from α-glucans, such as dextrans, pullulans, starches and starch degradation products, such as dextrins. Especially, the polysaccharide compound is a dextran, which optionally bear at least one group NH₂-A²-X³—.

Suitable enzymes, which are capable of catalyzing an esterification or amidation reaction, such as lipases, are commercially available, e. g. from Novozyme.

The reaction is preferably carried out in an aprotic organic solvent, such as dimethyl sulfoxide, N,N-dimethylacetamide, N,N-dimethylformamide, N-methyl-2-pyrrolidone, acetonitrile, tetrahydrofuran, dimethylpropyleneurea, acetone, butanone, sulfolane, pyridine, triethylamine, hexamethylphosphoramide or mixtures thereof.

Preferably, the water formed in the esterification reaction or transesterification reaction is removed, e. g. by distillation and/or by using molecular sieves.

As mentioned before, the conjugates of the invention, preferably non-ionic conjugates of the invention stabilize aqueous emulsions of a water-immiscible liquid. For this, a stabilizing amount of the conjugate is incorporated into the emulsion of the water-immiscible liquid.

Preferably, the aqueous emulsions of a water-immiscible liquid is an oil in water emulsion (o/w emulsion). Oil-in-water emulsion is defined as a mixture including two immiscible liquids, i. e. oil and water, in which oil is distributed into the water. Oil builds therefore the dispersed phase of the o/w emulsion while water the continuous phase. In a water in oil emulsion (w/o emulsion), water builds the dispersed phase in the continuous oil phase.

Depending on the energy input into the mixture of the aqueous phase and the water-immiscible liquid, it is possible to control the droplet size. Furthermore, the type and amount of dispersant described above influence the size of the emulsion droplets in equilibrium. A suitable amount can be chosen by routine. For the purpose of the invention, it has been found beneficial, if the final average particle size D[v, 0.5] of microparticles will not exceed 400 μm, in particular 200 μm and especially 100 μm.

Here and hereinafter, all figures for particle sizes, particle diameters and particle size distributions, including the D[v, 0.1], D[v, 0.5], D[v, 0.9], D[4,3] and D[3,2] values, are based on the particle size distributions ascertained by static laser light scattering to ISO 13320:2009 on samples of the microparticles. The abbreviation SLS is also used hereinafter for the expression “static laser light scattering to ISO 13320:2009”. In this connection, the D[v, 0.1] value means that 10% by volume of the particles of the measured sample have a particle diameter below the value reported as D[v, 01]. Accordingly, the D[v, 0.5] value means that 50% by volume of the particles of the measured sample have a particle diameter below the value reported as D[v, 0.5], and the D[v, 0.9] value means that 90% by volume of the particles of the measured sample have a particle diameter below the value reported as D[v, 0.9]. The D[4,3] value is the volume-weighted average determined by means of SLS, which is also referred to as the De Brouckere mean and corresponds to the mass average for the particles of the invention. The D[3, 2] value is the surface-weighted average determined by means of SLS, which is also referred to as the Sauter mean diameter (SMD).

While stirring will usually produce droplets having an average droplet size D[v, 0.5] of at most or below 400 μm, in particular at most 200 μm and especially at most 100 μm, e.g. in the range of 0.5 to 400 μm, in particular 1 to 200 μm, especially 1 to 100 μm are achieved by means of apparatuses for generating a high shear field. It is also possible to introduce sufficient shear energy by vigorous stirring that average droplet sizes with D[v, 0.5] values in the range from 0.5 to 400 μm, preferably of 1 to 200 μm and especially 1 to 100 μm are achieved. Should even higher shear energy input be intended, it may be advantageous to use apparatuses for generating a high shear field.

By adjusting the droplet size of the emulsion, in particular o/w emulsion and droplet size distribution, it is possible to adjust the particle size and particle size distribution of the final droplets containing the organic active compounds. In other words, a small average particle size of the droplets is achieved by providing an emulsion, in particular an o/w emulsion having a small average droplet size and likewise a narrow droplet size distribution of the emulsion, in particular the o/w emulsion will result in a narrow particle size distribution of the obtained droplets containing the organic active compound.

Suitable stirrer types include propeller stirrers, impeller stirrers, disk stirrers, paddle stirrers, anchor stirrers, pitched-blade stirrers, cross-beam stirrers, helical stirrers, screw stirrers and others.

Suitable apparatuses for shearing, i.e. for generating a high shear field, are dispersing machines operating by the rotor-stator principle, i.e. rotor stator mixer, such as toothed ring dispersing machines also termed gear dispersing machines, further colloid mills and disk mills, high-pressure homogenizers, also termed high pressure mixers, and ultrasound homogenizers. High shear may also be achieved by using a dispersing disc or a cross-blade stirrer with one or multiple stages. Amongst apparatuses for shearing, preference is given to dispersing machines operating by the rotor-stator principle for generating the shear field, in particular to toothed ring dispersing machines. The diameter of the rotors and stators is typically in the range between 1 cm and 40 cm, depending on machine size and dispersing performance. The speed of rotation of such dispersing machines is generally in the range from 500 to 20 000 rpm, in particular from 1000 to 15000 rpm (revolutions per minute), depending on the construction type. Of course, machines with large rotor diameters rotate at the lower end of the rotation speed range, while machines with small rotor diameters are usually operated at the upper end of the rotation speed range. The circumferential speed of the rotor is typically in the range of 5 to 50 m/s. The distance of the rotating parts from the stationary parts of the dispersing tool is generally 0.1 to 3 mm.

As mentioned above, droplet size can be controlled by the shear energy input into the mixture of the aqueous phase and the water-immiscible liquid. The shear energy introduced can be directly derived from the power consumption of the apparatus for generating a shear field, taking account of the heat loss. Thus, the shear energy input into the o/w emulsion is preferably 250 to 25 000 watts h/m³ batch size. Particular preference is given to an energy input of 500 to 15 000, especially 800 to 10 000, watts h/m³ batch size, calculated based on the motor current.

In a preferred embodiment, the emulsification is carried out such that the emulsion droplets of the emulsion, in particular o/w emulsion have an average diameter D[v, 0.5], determined by means of light scattering, of at most or below 400 μm, e.g. in the range of 0.5 to 400 μm, in particular in the range of 1 to 200 μm and especially 1 to 100 μm. For this, the emulsification typically comprises mixing the solution of step i. with the aqueous phase and homogenization of the mixture. Homogenization is typically achieved by subjecting the mixture to high shear using a suitable device as described above. Mixing and homogenization can be carried out successively or simultaneously.

Frequently, the conjugate will be used in an amount in the range of 1 to 50% by weight, in particular in the range of 2 to 40% by weight, more particularly in the range of 5 to 35% by weight and especially in the range of 8 to 30% by weight, based on the weight of the water-immiscible liquid phase of the aqueous emulsion, in particular of the oil phase of the o/w emulsion which contains the pesticide compound.

The weight ratio of the conjugate to the water-immiscible liquid of the emulsion is in the range of 1:100 to 1:1, in particular in the range of 1:50 to 1:2, especially in the range of 1:30 to 1:3.

For example, the aqueous emulsion of the water-immiscible liquid can be stabilized by dissolving the conjugate, in particular non-ionic conjugate in the water used for the emulsification of the water-immiscible liquid. In case that the organic active compound is solid at 22° C., the solid is dissolved in a water-immiscible organic solvent and the solution thereof is preferably used to form the aqueous emulsion according to the invention. It may also be possible to mix the solid or a solution thereof in a water-immiscible organic solvent with the conjugate first followed by emulsification of the mixture in water.

The emulsification of the water-immiscible liquid in water in the presence of the conjugate, in particular non-ionic conjugate can be achieved by mixing the components forming the emulsion, i. e. the water-immiscible liquid, water, then the conjugate, in particular the non-ionic conjugate and optionally the water-immiscible organic solvent in any order in a suitable mixing device. It may be beneficial when the emulsification comprises a homogenization step to reduce the droplet size of the non-aqueous droplets of the emulsion. Homogenization can be achieved in well known manner, e. g. by using a microfluidizer or a high-pressure homogenizer.

The concentration of the water-immiscible liquid in the aqueous emulsion, may vary and is typically in the range of 0.1 to 60% by weight, in particular in the range of 1 to 45% by weight, especially in the range of 1.5 to 40% by weight, based on the total weight of the emulsion.

The conjugate can principally be used for stabilizing any aqueous emulsion of any water-immiscible liquid. For this, principally any water-immiscible liquid being able to be emulsified in water can be used. For example, if the water-immiscible liquid is liquid at 22° C., it can be emulsified as such without the need of a water-immiscible solvent. If the water-immiscible liquid is solid at 22° C., it is preferred to dissolve the solid compound in a water-immiscible solvent and emulsify the solution in water.

Suitable water-immiscible liquids are therefore liquid at 22° C. or in case of solid at 22° C. they can be dissolved in water-immiscible solvents. Usually, the water-immiscible liquid is a non-ionic organic compound. In particular, the water-immiscible liquid is a non-ionic organic compound whose molecules have from 6 to 50 atoms other than hydrogen, which are in particular selected from C, O, S, N, P and halogen. The miscibility of the water-immiscible liquid in water will generally not exceed 5 g/l or be at most 3 g/l or at most 2 g/l, as determined at 20° C. and 1 mbar.

In particular, the water-immiscible liquid of the aqueous emulsion comprises at least one organic active compound, in particular at least one pesticide compound. In this case, it is no matter, whether the organic active compound itself is liquid at 22° C. and forms the non-aqueous droplets in the aqueous emulsion or is solid at 22° C. and dissolved in a water-immiscible solvent, which forms the droplets in the emulsion.

Usually, the organic active compound is a non-ionic organic compound. In particular, the organic active compound is a non-ionic organic compound whose molecules have from 6 to 50 atoms other than hydrogen, which are in particular selected from C, O, S, N, P and halogen. The solubility of the organic active compound in water will generally not exceed 5 g/l or be at most 3 g/l or at most 2 g/l, as determined at 20° C. and 1 mbar.

Preferably, the organic active compound is a water-immiscible liquid at 22° C. and/or dissolved in a water-immiscible organic solvent.

The concentration of the organic active compound in the composition may vary and is typically in the range of 10 to 800 g/kg of the composition.

The organic active compound is frequently selected from agrochemicals, in particular pesticides, aromachemicals, pharmaceutically active compounds, vitamins, cosmetic actives and organic effect compounds. The preference is given to agrochemicals, in particular pesticides.

In a preferred group of embodiments, the organic active is an aroma chemical, especially an aroma chemical, which is liquid at 22° C. and 1 bar or a mixture of two or more aroma chemicals which is liquid at 22° C. and 1 bar. Preferred aroma chemicals are hydrophobic and, especially at 25° C., have a water solubility in deionized water of not more than 1 g/L.

The term “aroma chemical” is understood by the person skilled in the art to mean organic compounds usable as “odorant” and/or as “flavoring”. In the context of the present invention, “odorant” is understood to mean natural or synthetic substances having intrinsic odor. In the context of the present invention, “flavoring” is understood to mean natural or synthetic substances having intrinsic flavor. In the context of the present invention, “odor” or “olfactory perception” is the interpretation of the sensory stimuli, which are sent from the chemoreceptors in the nose or other olfactory organs to the brain of a living being. The odor can be a result of sensory perception of the nose of odorant, which occurs during inhalation. In this case, the air serves as odor carrier.

Preferred aroma chemicals are selected, for example, from the following compounds:
alpha-hexylcinnamaldehyde, 2-phenoxyethyl isobutyrate (Phenirat¹), dihydromyrcenol (2,6-dimethyl-7-octen-2-ol), methyl dihydrojasmonate (preferably having a cis isomer content of more than 60% by weight) (Hedione⁹, Hedione HC⁹), 4,6,6,7,8,8-hexamethyl-1,3,4,6,7,8-hexahydrocyclopenta[g]benzopyran (Galaxolide³), tetrahydrolinalool (3,7-dimethyloctan-3-ol), ethyl linalool, benzyl salicylate, 2-methyl-3-(4-tert-butylphenyl)propanal (Lilial²), cinnamyl alcohol, 4,7-methano-3a,4,5,6,7,7a-hexahydro-5-indenyl acetate and/or 4,7-methano-3a,4,5,6,7,7a-hexahydro-6-indenyl acetate (Herbaflorat¹), citronellol, citronellyl acetate, tetrahydrogeraniol, vanillin, linalyl acetate, styrenyl acetate (1-phenylethyl acetate), octahydro-2,3,8,8-tetramethyl-2-acetonaphthone and/or 2-acetyl-1,2,3,4,6,7,8-octahydro-2,3,8,8-tetramethylnaphthalene (Iso E Super³), hexyl salicylate, 4-tert-butylcyclohexyl acetate (Oryclone¹), 2-tert-butylcyclohexyl acetate (Agrumex HC¹), alpha-ionone (4-(2,2,6-trimethyl-2-cyclohexen-1-yl)-3-buten-2-one), n-alpha-methylionone, alpha-isomethylionone, coumarin, terpinyl acetate, 2-phenylethyl alcohol, 4-(4-hydroxy-4-methylpentyl)-3-cyclohexenecarboxaldehyde (Lyral³), alpha-amylcinnamaldehyde, ethylene brassylate, (E)- and/or (Z)-3-methylcyclopentadec-5-enone (Muscenone⁹), 15-pentadec-11-enolide and/or
15-pentadec-12-enolide (Globalide¹), 15-cyclopentadecanolide (Macrolide¹), 1-(5,6,7,8-tetrahydro-3,5,5,6,8,8-hexamethyl-2-naphthalenyl)ethanone (Tonalide¹⁰), 2-isobutyl-4-methyltetrahydro-2H-pyran-4-ol (Florol⁹), 2-ethyl-4-(2,2,3-trimethyl-3-cyclopenten-1-yl)-2-buten-1-ol (Sandolene¹), cis-3-hexenyl acetate, trans-3-hexenyl acetate, trans-2-cis-6-nonadienol, 2,4-dimethyl-3-cyclohexenecarboxaldehyde (Vertocitral¹), 2,4,4,7-tetramethyloct-6-en-3-one (Claritone¹), 2,6-dimethyl-5-hepten-1-al (Melonal²), borneol, 3-(3-isopropylphenyl)butanal (Florhydral²), 2-methyl-3-(3,4-methylenedioxyphenyl)propanal (Helional³), 3-(4-ethylphenyl)-2,2-dimethylpropanal (Florazon¹), tetrahydro-2-isobutyl-4-methyl-2H-pyran (Dihydrorosenon⁴),
1,4-bis(ethoxymethyl)cyclohexane (Vertofruct⁴), L-isopulegol (1R,2S,5R)-2-isopropenyl-5-methylcyclohexanol, pyranyl acetate (2-isobutyl-4-methyltetrahydropyran-4-yl acetate), nerol ((Z)-2,6-dimethyl-2,6-octadien-8-ol), neryl acetate, 7-methyl-2H-1,5-benzodioxepin-3(4H)-one (Calonel¹⁹⁵¹⁵), 3,3,5-trimethylcyclohexyl acetate (preferably with a content of cis isomers of 70% by weight) or more and 2,5,5-trimethyl-1,2,3,4,4a,5,6,7-octahydronaphthalen-2-ol (Ambrinol S¹), tetrahydro-4-methyl-2-(2-methylpropenyl)-2H-pyran (rose oxide), 4-methyl-2-(2-methylpropyl)oxane or 4-methyl-2-(2-methylpropyl)-2H-pyran (Dihydrorosan⁴), prenyl acetate (=3-methylbut-2-enyl acetate), isoamyl acetate, dihydromyrcenol (2,6-dimethyloct-7-en-2-ol) and methylheptenone (6-methylhept-5-en-2-one) and mixtures thereof, and also mixtures thereof with one or more other aromas.

In the context of the present invention, the aforementioned aromas or odorants are accordingly preferably combined with mixtures of the invention.

If trade names are specified above, these refer to the following sources:
¹ trade name of Symrise GmbH, Germany;
² trade name of Givaudan AG, Switzerland;
³ trade name of International Flavors & Fragrances Inc., USA;
⁴ trade name of BASF SE;
⁵ trade name of Danisco Seillans S.A., France;
⁹ trade name of Firmenich S.A., Switzerland;
¹⁰ trade name of PFW Aroma Chemicals B.V., the Netherlands.

More particularly, the advantages of the invention are manifested in the case of aroma chemicals that are selected from volatile fragrances and aroma mixtures comprising at least one volatile fragrance. Volatile fragrances are understood to mean fragrances having a high vapor pressure at room temperature. A fragrance is considered to be a volatile fragrance especially when it has the following property: If a droplet of the volatile fragrance is applied to a strip of paper and left to evaporate off under ambient conditions at room temperature (22° C.), its odor is no longer perceptible to an experienced perfumer 2 hours after application. The volatile fragrances especially include the following compounds: rose oxide (tetrahydro-4-methyl-2-(2-methylpropenyl)-2H-pyran), 4-methyl-2-(2-methylpropyl)oxane or 4-methyl-2-(2-methylpropyl)-2H-pyran (Dihydrorosan®), prenyl acetate (=3-methylbut-2-enyl acetate), isoamyl acetate, dihydromyrcenol (2,6-dimethyloct-7-en-2-ol) and methylheptenone (6-methylhept-5-en-2-one). If an aroma mixture comprising at least one volatile fragrance is used for loading, the proportion of the volatile fragrance is generally at least 1% by weight, especially at least 5% by weight, for example 1% to 99% by weight, especially 5% to 95% by weight, based on the total weight of the aroma chemical mixture used for loading.

Further odorants or aroma chemicals with which the odorants mentioned can be combined to give an odorant composition can be found, for example, in S. Arctander, Perfume and Flavor Chemicals, Vol. I and II, Montclair, N. J., 1969, Author's edition or K. Bauer, D. Garbe and H. Surburg, Common Fragrance and Flavor Materials, 4th. Ed., Wiley-VCH, Weinheim 2001. Specifically, the following may be mentioned:

Extracts from natural raw materials such as essential oils, concretes, absolutes, resins, resinoids, balsams, tinctures, for example ambra tincture; amyris oil; Angelica seed oil; Angelica root oil; anise oil; valerian oil; basil oil; tree moss absolute; bay oil; mugwort oil; benzoin resin; bergamot oil; beeswax absolute; birch tar oil; bitter almond oil; savory oil; bucco leaf oil; cabreuva oil; cade oil; calamus oil; camphor oil; Cananga oil; cardamom oil; cascarilla oil; Cassia oil; cassie absolute; castoreum absolute; cedar leaf oil; cedar wood oil; cistus oil; citronella oil; lemon oil; copaiba balsam; copaiba balsam oil; coriander oil; costus root oil; cumin oil; cypress oil; davana oil; dill oil; dill seed oil; eau de brouts absolute; oakmoss absolute; elemi oil; estragon oil; Eucalyptus citriodora oil; Eucalyptus oil; fennel oil; spruce needle oil; Galbanum oil; Galbanum resin; geranium oil; grapefruit oil; guaiac wood oil; gurjun balsam; gurjun balsam oil; helichrysum absolute; helichrysum oil; ginger oil; iris root absolute; iris root oil; jasmine absolute; calamus oil; camellia oil blue; camellia oil roman; carrot seed oil; cascarilla oil; pine needle oil; spearmint oil; cumin oil; labdanum oil; labdanum absolute; labdanum resin; lavandin absolute; lavandin oil; lavender absolute; lavender oil; lemon grass oil; lovage oil; lime oil distilled; lime oil pressed; linalool oil; Litsea cubeba oil; laurel leaf oil; macis oil; marjoram oil; mandarin oil; Massoia bark oil; Mimosa absolute; musk seed oil; musk tincture; clary sage oil; nutmeg oil; myrrh absolute; myrrh oil; myrtle oil; clove leaf oil; clove flower oil; neroli oil; olibanum absolute; olibanum oil; opopanax oil; orange blossom absolute; orange oil; oregano oil; palmarosa oil; patchouli oil; Perilla Oil; Peruvian balsam oil; parsley leaf oil; parsley seed oil; petitgrain oil; peppermint oil; pepper oil; allspice oil; pine oil; poley oil; rose absolute; rosewood oil; rose oil; rosemary oil; sage oil dalmatian; sage oil Spanish; sandalwood oil; celery seed oil; spike lavender oil; star anise oil; Styrax oil; Tagetes oil; fir needle oil; tea tree oil; turpentine oil; thyme oil; tolu balsam; tonka absolute; tuberose absolute; vanilla extract; violet leaf absolute; Verbena oil; vetiver oil; juniper berry oil; wine yeast oil; vermouth oil; wintergreen oil; ylang oil; hyssop oil; civet absolute; cinnamon leaf oil; cinnamon bark oil; and fractions thereof or ingredients isolated therefrom.

Individual odorants are, for example, those from the group of
the hydrocarbons, for example 3-carene; alpha-pinene; beta-pinene; alpha-terpinene; gamma-terpinene; p-cymene; bisabolene; camphene; caryophyllene; cedrene; farnesene; limonene; longifolene; myrcene; ocimene; valencene; (E,Z)-1,3,5-undecatriene; styrene; diphenylmethane;
the aliphatic alcohols, for example hexanol; octanol; 3-octanol; 2,6-dimethyl-heptanol; 2-methyl-2-heptanol; 2-methyl-2-octanol; (E)-2-hexenol; (E)- and (Z)-3-hexenol; 1-octen-3-ol; mixture of 3,4,5,6,6-pentamethyl-3/4-hepten-2-ol and 3,5,6,6-tetramethyl-4-methyleneheptan-2-ol; (E,Z)-2,6-nonadienol; 3,7-dimethyl-7-methoxyoctan-2-ol; 9-decenol; 10-undecenol; 4-methyl-3-decen-5-ol;
the aliphatic aldehydes and acetals thereof, for example hexanal; heptanal; octanal; nonanal; decanal; undecanal; dodecanal; tridecanal; 2-methyloctanal; 2-methylnonanal; (E)-2-hexenal; (Z)-4-heptenal; 2,6-dimethyl-5-heptenal; 10-undecenal; (E)-4-decenal; 2-dodecenal; 2,6,10-trimethyl-9-undecenal; 2,6,10-trimethyl-5,9-undecadienal; heptanal diethylacetal; 1,1-dimethoxy-2,2,5-trimethyl-4-hexene; citronellyloxyacetaldehyde; (E/Z)-1-(1-methoxypropoxy)-3-hexene; the aliphatic ketones and oximes thereof, for example 2-heptanone; 2-octanone; 3-octanone; 2-nonanone; 5-methyl-3-heptanone; 5-methyl-3-heptanone oxime; 2,4,4,7-tetramethyl-6-octen-3-one; 6-methyl-5-hepten-2-one;
the aliphatic sulfur-containing compounds, for example 3-methylthiohexanol; 3-methylthiohexyl acetate; 3-mercaptohexanol; 3-mercaptohexyl acetate; 3-mercaptohexyl butyrate; 3-acetylthiohexyl acetate; 1-menthene-8-thiol;
the aliphatic nitriles, for example 2-nonenenitrile; 2-undecenenitrile; 2-tridecenenitrile; 3,12-tridecadienenitrile; 3,7-dimethyl-2,6-octadienenitrile; 3,7-dimethyl-6-octenenitrile;
the esters of aliphatic carboxylic acids, for example (E)- and (Z)-3-hexenyl formate; ethyl acetoacetate; isoamyl acetate; hexyl acetate; 3,5,5-trimethylhexyl acetate; 3-methyl-2-butenyl acetate; (E)-2-hexenyl acetate; (E)- and (Z)-3-hexenyl acetate; octyl acetate; 3-octyl acetate; 1-octen-3-yl acetate; ethyl butyrate; butyl butyrate; isoamyl butyrate; hexyl butyrate; (E)- and (Z)-3-hexenyl isobutyrate; hexyl crotonate; ethyl isovalerate; ethyl 2-methylpentanoate; ethyl hexanoate; allyl hexanoate; ethyl heptanoate; allyl heptanoate; ethyl octanoate; (E/Z)-ethyl 2,4-decadienoate; methyl 2-octynoate; methyl 2-nonynoate; allyl 2-isoamyloxyacetate; methyl 3,7-dimethyl-2,6-octadienoate; 4-methyl-2-pentyl crotonate;
the acyclic terpene alcohols, for example geraniol; nerol; linalool; lavandulol; nerolidol; farnesol; tetrahydrolinalool; 2,6-dimethyl-7-octen-2-ol; 2,6-dimethyloctan-2-ol; 2-methyl-6-methylene-7-octen-2-ol; 2,6-dimethyl-5,7-octadien-2-ol; 2,6-dimethyl-3,5-octadien-2-ol; 3,7-dimethyl-4,6-octadien-3-ol; 3,7-dimethyl-1,5,7-octatrien-3-ol; 2,6-dimethyl-2,5,7-octatrien-1-ol; and the formates, acetates, propionates, isobutyrates, butyrates, isovalerates, pentanoates, hexanoates, crotonates, tiglinates and 3-methyl-2-butenoates thereof;
the acyclic terpene aldehydes and ketones, for example geranial; neral; citronellal; 7-hydroxy-3,7-dimethyloctanal; 7-methoxy-3,7-dimethyloctanal; 2,6,10-trimethyl-9-undecenal; geranyl acetone; and also the dimethyl and diethyl acetals of geranial, neral, 7-hydroxy-3,7-dimethyloctanal; the cyclic terpene alcohols, for example menthol; isopulegol; alpha-terpineol; terpineol-4; menthan-8-ol; menthan-1-ol; menthan-7-ol; borneol; isoborneol; linalool oxide; nopol; cedrol; ambrinol; vetiverol; guajol; and the formates, acetates, propionates, isobutyrates, butyrates, isovalerates, pentanoates, hexanoates, crotonates, tiglinates and 3-methyl-2-butenoates thereof;
the cyclic terpene aldehydes and ketones, for example menthone; isomenthone; 8-mercaptomenthan-3-one; carvone; camphor; fenchone; alpha-ionone; beta-ionone; alpha-n-methylionone; beta-n-methylionone; alpha-isomethylionone; beta-isomethylionone; alpha-irone; alpha-damascone; beta-damascone; beta-damascenone; delta-damascone; gamma-damascone; 1-(2,4,4-trimethyl-2-cyclohexen-1-yl)-2-buten-1-one; 1,3,4,6,7,8a-hexahydro-1,1,5,5-tetramethyl-2H-2,4a-methanonaphthalene-8(5H)-one; 2-methyl-4-(2,6,6-trimethyl-1-cyclohexen-1-yl)-2-butenal; nootkatone; dihydronootkatone; 4,6,8-megastigmatrien-3-one; alpha-sinensal; beta-sinensal; acetylated cedar wood oil (methyl cedryl ketone);
the cyclic alcohols, for example 4-tert-butylcyclohexanol; 3,3,5-trimethylcyclo-hexanol; 3-isocamphylcyclohexanol; 2,6,9-trimethyl-Z2,Z5,E9-cyclododecatrien-1-ol; 2-isobutyl-4-methyltetrahydro-2H-pyran-4-ol;
the cycloaliphatic alcohols, for example alpha-3,3-trimethylcyclohexylmethanol; 1-(4-isopropylcyclohexyl)ethanol; 2-methyl-4-(2,2,3-trimethyl-3-cyclopent-1-yl)butanol; 2-methyl-4-(2,2,3-trimethyl-3-cyclopent-1-yl)-2-buten-1-ol; 2-ethyl-4-(2,2,3-trimethyl-3-cyclopent-1-yl)-2-buten-1-ol; 3-methyl-5-(2,2,3-trimethyl-3-cyclopent-1-yl)pentan-2-ol; 3-methyl-5-(2,2,3-trimethyl-3-cyclopent-1-yl)-4-penten-2-ol; 3,3-dimethyl-5-(2,2,3-trimethyl-3-cyclopent-1-yl)-4-penten-2-ol; 1-(2,2,6-trimethylcyclohexyl)pentan-3-ol; 1-(2,2,6-trimethylcyclohexyl)hexan-3-ol;
the cyclic and cycloaliphatic ethers, for example cineol; cedryl methyl ether; cyclododecyl methyl ether; 1,1-dimethoxycyclododecane; 1,4-bis(ethoxy-methyl)cyclohexane; (ethoxymethoxy)cyclododecane; alpha-cedrene epoxide; 3a,6,6,9a-tetramethyldodecahydronaphtho[2,1-b]furan; 3a-ethyl-6,6,9a-trimethyldodecahydronaphtho[2,1-b]furan; 1,5,9-trimethyl-13-oxabicyclo[10.1.0]trideca-4,8-diene; rose oxide; 2-(2,4-dimethyl-3-cyclohexen-1-yl)-5-methyl-5-(1-methylpropyl)-1,3-dioxane;
the cyclic and macrocyclic ketones, for example 4-tert-butylcyclohexanone; 2,2,5-trimethyl-5-pentylcyclopentanone; 2-heptylcyclopentanone; 2-pentyl-cyclopentanone; 2-hydroxy-3-methyl-2-cyclopenten-1-one; cis-3-methylpent-2-en-1-ylcyclopent-2-en-1-one; 3-methyl-2-pentyl-2-cyclopenten-1-one; 3-methyl-4-cyclopentadecenone; 3-methyl-5-cyclopentadecenone; 3-methylcyclopentadecanone; 4-(1-ethoxyvinyl)-3,3,5,5-tetramethylcyclohexanone; 4-tert-pentylcyclohexanone; cyclohexadec-5-en-1-one; 6,7-dihydro-1,1,2,3,3-pentamethyl-4(5H)-indanone; 8-cyclohexadecen-1-one; 7-cyclohexadecen-1-one; (7/8)-cyclohexadecen-1-one; 9-cycloheptadecen-1-one; cyclopentadecanone; cyclohexadecanone;
the cycloaliphatic aldehydes, for example 2,4-dimethyl-3-cyclohexene-carbaldehyde; 2-methyl-4-(2,2,6-trimethylcyclohexen-1-yl)-2-butenal; 4-(4-hydroxy-4-methylpentyl)-3-cyclohexenecarbaldehyde; 4-(4-methyl-3-penten-1-yl)-3-cyclohexenecarbaldehyde;
the cycloaliphatic ketones, for example 1-(3,3-dimethylcyclohexyl)-4-penten-1-one; 2,2-dimethyl-1-(2,4-dimethyl-3-cyclohexen-1-yl)-1-propanone; 1-(5,5-dimethyl-1-cyclohexen-1-yl)-4-penten-1-one; 2,3,8,8-tetramethyl-1,2,3,4,5,6,7,8-octahydro-2-naphthalenyl methyl ketone; methyl 2,6,10-trimethyl-2,5,9-cyclododecatrienyl ketone; tert-butyl (2,4-dimethyl-3-cyclohexen-1-yl) ketone;
the esters of cyclic alcohols, for example 2-tert-butylcyclohexyl acetate; 4-tert-butylcyclohexyl acetate; 2-tert-pentylcyclohexyl acetate; 4-tert-pentylcyclohexyl acetate; 3,3,5-trimethylcyclohexyl acetate; decahydro-2-naphthyl acetate; 2-cyclopentylcyclopentyl crotonate; 3-pentyltetrahydro-2H-pyran-4-yl acetate; decahydro-2,5,5,8a-tetramethyl-2-naphthyl acetate; 4,7-methano-3a,4,5,6,7,7a-hexahydro-5- or -6-indenyl acetate; 4,7-methano-3a,4,5,6,7,7a-hexahydro-5- or -6-indenyl propionate; 4,7-methano-3a,4,5,6,7,7a-hexahydro-5- or -6-indenyl isobutyrate; 4,7-methanooctahydro-5- or -6-indenyl acetate;
the esters of cycloaliphatic alcohols, for example 1-cyclohexylethyl crotonate;
the esters of cycloaliphatic carboxylic acids, for example allyl 3-cyclohexyl-propionate; allyl cyclohexyloxyacetate; cis- and trans-methyl dihydrojasmonate; cis- and trans-methyl jasmonate; methyl 2-hexyl-3-oxocyclopentanecarboxylate; ethyl 2-ethyl-6,6-dimethyl-2-cyclohexenecarboxylate; ethyl 2,3,6,6-tetramethyl-2-cyclohexenecarboxylate; ethyl 2-methyl-1,3-dioxolane-2-acetate;
the araliphatic alcohols, for example benzyl alcohol; 1-phenylethyl alcohol, 2-phenylethyl alcohol, 3-phenylpropanol; 2-phenylpropanol; 2-phenoxyethanol; 2,2-dimethyl-3-phenylpropanol; 2,2-dimethyl-3-(3-methylphenyl)propanol; 1,1-dimethyl-2-phenylethyl alcohol; 1,1-dimethyl-3-phenylpropanol; 1-ethyl-1-methyl-3-phenylpropanol; 2-methyl-5-phenylpentanol; 3-methyl-5-phenylpentanol; 3-phenyl-2-propen-1-ol; 4-methoxybenzyl alcohol; 1-(4-isopropylphenyl)ethanol;
the esters of araliphatic alcohols and aliphatic carboxylic acids, for example benzyl acetate; benzyl propionate; benzyl isobutyrate; benzyl isovalerate; 2-phenylethyl acetate; 2-phenylethyl propionate; 2-phenylethyl isobutyrate; 2-phenylethyl isovalerate; 1-phenylethyl acetate; alpha-trichloromethylbenzyl acetate; alpha,alpha-dimethylphenylethyl acetate; alpha,alpha-dimethylphenylethyl butyrate; cinnamyl acetate; 2-phenoxyethyl isobutyrate; 4-methoxybenzyl acetate;
the araliphatic ethers, for example 2-phenylethyl methyl ether; 2-phenylethyl isoamyl ether; 2-phenylethyl 1-ethoxyethyl ether; phenylacetaldehyde dimethyl acetal; phenylacetaldehyde diethyl acetal; hydratropaaldehyde dimethyl acetal; phenylacetaldehyde glycerol acetal; 2,4,6-trimethyl-4-phenyl-1,3-dioxane; 4,4a,5,9b-tetrahydroindeno[1,2-d]-m-dioxin; 4,4a,5,9b-tetrahydro-2,4-dimethylindeno[1,2-d]-m-dioxin;
the aromatic and araliphatic aldehydes, for example benzaldehyde; phenylacetaldehyde; 3-phenylpropanal; hydratropaaldehyde; 4-methylbenz-aldehyde; 4-methylphenylacetaldehyde; 3-(4-ethylphenyl)-2,2-dimethylpropanal; 2-methyl-3-(4-isopropylphenyl)propanal; 2-methyl-3-(4-tert-butylphenyl) propanal; 2-methyl-3-(4-isobutylphenyl)propanal; 3-(4-tert-butylphenyl) propanal; cinnamaldehyde; alpha-butylcinnamaldehyde; alpha-amylcinnamaldehyde; alpha-hexylcinnamaldehyde; 3-methyl-5-phenylpentanal; 4-methoxybenzaldehyde; 4-hydroxy-3-methoxy-benzaldehyde; 4-hydroxy-3-ethoxybenzaldehyde; 3,4-methylenedioxybenzaldehyde; 3,4-dimethoxybenzaldehyde; 2-methyl-3-(4-methoxyphenyl)propanal; 2-methyl-3-(4-methylene-dioxyphenyl) propanal;
the aromatic and araliphatic ketones, for example acetophenone; 4-methyl-acetophenone; 4-methoxyacetophenone; 4-tert-butyl-2,6-dimethylaceto-phenone; 4-phenyl-2-butanone; 4-(4-hydroxyphenyl)-2-butanone; 1-(2-naphthalenyl)ethanone; 2-benzofuranylethanone; (3-methyl-2-benzofuranyl) ethanone; benzophenone; 1,1,2,3,3,6-hexamethyl-5-indanyl methyl ketone; 6-tert-butyl-1,1-dimethyl-4-indanyl methyl ketone; 1-[2,3-dihydro-1,1,2,6-tetramethyl-3-(1-methylethyl)-1H-5-indenyl]ethanone; 5′,6′,7′,8′-tetrahydro-3′,5′,5′,6′,8′,8′-hexamethyl-2-acetonaphthone;
the aromatic and araliphatic carboxylic acids and esters thereof, for example benzoic acid; phenylacetic acid; methyl benzoate; ethyl benzoate; hexyl benzoate; benzyl benzoate; methyl phenylacetate; ethyl phenylacetate; geranyl phenylacetate; phenylethyl phenylacetate; methyl cinnamate; ethyl cinnamate; benzyl cinnamate; phenylethyl cinnamate; cinnamyl cinnamate; allyl phenoxyacetate; methyl salicylate; isoamyl salicylate; hexyl salicylate; cyclohexyl salicylate; cis-3-hexenyl salicylate; benzyl salicylate; phenylethyl salicylate; methyl 2,4-dihydroxy-3,6-dimethylbenzoate; ethyl 3-phenylglycidate; ethyl 3-methyl-3-phenylglycidate;
the nitrogen-containing aromatic compounds, for example 2,4,6-trinitro-1,3-dimethyl-5-tert-butylbenzene; 3,5-dinitro-2,6-dimethyl-4-tert-butylacetophenone; cinnamonitrile; 3-methyl-5-phenyl-2-pentenonitrile; 3-methyl-5-phenylpentanonitrile; methyl anthranilate; methyl N-methylanthranilate; Schiff's bases of methyl anthranilate with 7-hydroxy-3,7-dimethyloctanal, 2-methyl-3-(4-tert-butylphenyl)propanal or 2,4-dimethyl-3-cyclohexenecarbaldehyde; 6-isopropylquinoline; 6-isobutylquinoline; 6-sec-butylquinoline; 2-(3-phenylpropyl)pyridine; indole; skatole; 2-methoxy-3-isopropylpyrazine; 2-isobutyl-3-methoxypyrazine;
the phenols, phenyl ethers and phenyl esters, for example estragole; anethole; eugenol; eugenyl methyl ether; isoeugenol; isoeugenyl methyl ether; thymol; carvacrol; diphenyl ether; beta-naphthyl methyl ether; beta-naphthyl ethyl ether; beta-naphthyl isobutyl ether; 1,4-dimethoxybenzene; eugenyl acetate; 2-methoxy-4-methylphenol; 2-ethoxy-5-(1-propenyl)phenol; p-cresyl phenyl-acetate;
the heterocyclic compounds, for example 2,5-dimethyl-4-hydroxy-2H-furan-3-one; 2-ethyl-4-hydroxy-5-methyl-2H-furan-3-one; 3-hydroxy-2-methyl-4H-pyran-4-one; 2-ethyl-3-hydroxy-4H-pyran-4-one;
the lactones, for example 1,4-octanolide; 3-methyl-1,4-octanolide; 1,4-nonanolide; 1,4-decanolide; 8-decen-1,4-olide; 1,4-undecanolide; 1,4-dodecanolide; 1,5-decanolide; 1,5-dodecanolide; 4-methyl-1,4-decanolide; 1,15-pentadecanolide; cis- and trans-11-pentadecen-1,15-olide; cis- and trans-12-pentadecen-1,15-olide; 1,16-hexadecanolide; 9-hexadecen-1,16-olide;
10-oxa-1,16-hexadecanolide; 11-oxa-1,16-hexadecanolide; 12-oxa-1,16-hexadecanolide; ethylene 1,12-dodecanedioate; ethylene 1,13-tridecanedioate; coumarin; 2,3-dihydrocoumarin; octahydrocoumarin.

In addition, suitable aroma chemicals are macrocyclic carbaldehyde compounds as described in WO 2016/050836.

Particular preference is given to mixtures of L-menthol and/or DL-menthol, L-menthone, L-menthyl acetate, or L-isopulegol, which are highly sought-after as analogs or substitutes for what are referred to as synthetic dementholized oils (DMOs). The mixtures of these minty compositions are preferably used in the ratio of L-menthol or DL-menthol 20-40% by weight, L-menthone 20-40% and L-menthyl acetate 0-20%, or in the ratio of 20-40% by weight, L-menthone 20-40% and L-isopulegol 0-20%.

The aforementioned aromas and aroma mixtures can be used as such or in a solvent which in itself is not an aroma. Typical solvents for aromas are especially those having a boiling point at standard pressure above 150° C. and which do not dissolve the wall material, e.g. diols such as propanediol and dipropylene glycol, C₈-C₂₂ fatty acid C₁-C₁₀-alkyl esters such as isopropyl myristate, di-C₆-C₁₀-alkyl ethers, e.g. dicapryl ether (Cetiol® OE from BASF SE), di-C₁-C₁₀-alkyl esters of aliphatic, aromatic or cycloaliphatic di- or tricarboxylic acids, for example dialkyl phthalates such as dimethyl and diethyl phthalate and mixtures thereof, dialkyl hexahydrophthalates, e.g. dimethyl cyclohexane-1,2-dicarboxylate, diethyl cyclohexane-1,2-dicarboxylate and diisononyl 1,2-cyclohexanedicarboxylate, and dialkyl adipates, such as dibutyl adipate (e.g. Cetiol® B from BASF SE), C₈-C₂₂ fatty acid triglycerides, e.g. vegetable oils or cosmetic oils such as octanoyl/decanoyltriglyceride (e.g. the commercial product Myritol® 318 from BASF SE), dimethyl sulfoxide and white oils.

In a further group of embodiments, the organic active of low molecular weight is an active pharmaceutical ingredient, API for short. Active pharmaceutical ingredients are typically active therapeutic ingredients, active diagnostic ingredients and active prophylactic ingredients, and corresponding combinations of active ingredients. The active pharmaceutical ingredient(s) may be in an amorphous state, a crystalline state or a mixture thereof. The active pharmaceutical ingredient(s) may be labelled with a detectable label such as a fluorescent label, a radioactive label or an enzymatic or chromatographically detectable species, and be used as a mixture with this label for loading of the microparticles.

The API may have a water solubility in deionized water of more than 10 mg/mL at 25° C. It is also possible to use active pharmaceutical ingredients having low water solubility as actives, for example those having a water solubility in deionized water of less than 10 mg/mL at 25° C. In any case, the API should have a partition coefficient with respect to the water-immiscible liquid and the aqueous phase of at least 1.0, in particular at least 2.0.

Preferred active therapeutic, diagnostic and prophylactic ingredients are those APIs that are suitable for parenteral administration. Representative examples of suitable APIs are the following categories and examples of APIs and alternative forms of these APIs, such as alternative salt forms, free acid forms, free base forms and hydrates:
analgesics/antipyretics; antiasthmatic drugs; antibiotics; antidepressants; antidiabetic drugs; antiphlogistics/inflammation inhibitors; antihypertensives; inflammation inhibitors; antineoplastics; antianxiety drugs; immunosuppressants; antimigraine drugs; tranquilizers/hypnotics; antitanginal drugs; antipsychotic drugs; antimanic drugs; antiarrhythmics; antiarthritic drugs; antigout drugs; anticoagulants; thrombolytic drugs; antifibrinolytic drugs; hemorheological drugs; antiplatelet drugs/thrombocyte aggregation inhibitors; anticonvulsives; anti-Parkinson's drugs; antihistamines/antipruritics; drugs for calcium regulation; antibacterial drugs; antiviral drugs; antimicrobial drugs; antiinfectives; bronchodilators; corticosteroids; steroidal compounds and hormones; hypoglycemic drugs; hypolipedemic drugs; proteins; nucleic acids; drugs useful for the stimulation of erythropoiesis; antiulcer drugs/antireflux drugs; antinausea drugs/antimosis drugs; oil-soluble vitamins and other medicaments.

Suitable active pharmaceutical ingredients are mentioned, for example, in WO 2007/070852, especially on pages 15 to 19. In addition, suitable active ingredients and drugs are listed in Martindale: The Extra Pharmacopoeia, 30th edition, The Pharmaceutical Press, London 1993.

In a further group of embodiments, the organic active is an agrochemical compound, i. e. an organic compound for crop protection, which is also termed as an organic crop protecting agent. Agrochemicals are, for example, pesticides, especially selected from the group consisting of fungicides, insecticides, nematicides, herbicides, pheromons, but also safeners, and growth regulators which can be included as single compounds but also as mixtures of different agrochemical compounds, for example as mixtures of two or more herbicides, mixtures of two or more fungicides, mixtures of two or more insecticides, mixtures of insecticides and fungicides, mixtures of one or more herbicides with a safener, and mixtures of one or more fungicides with a safener.

Typically, the agrochemicals are liquid or solid at 20° C. and 1 bar and are normally nonvolatile. The vapor pressure is typically below 0.1 mbar at 20° C., especially below 0.01 mbar. Agrochemicals, which are particularly are sparingly water-soluble or even insoluble in water and, especially at 25° C., have a water solubility in deionized water of not more than 5 g/L and especially not more than 2 g/L.

Agrochemicals are known to those skilled in the art, for example from The Pesticide Manual, 17th edition, The British Crop Protection Council, London, 2015. Suitable crop protecting agents are listed, especially, in WO 2018/019629 on pages 10 to 15.

Examples of suitable insecticides are compounds from the classes of the carbamates, organophosphates, organochlorine insecticides, phenylpyrazoles, pyrethroids, neonicotinoids, spinosins, avermectins, milbemycins, juvenile hormone analogs, alkyl halides, organotin compounds, nereistoxin analogs, benzoylureas, diacylhydrazines, METI acaricides, and unclassified insecticides such as chloropicrin, pymetrozine, flonicamid, clofentezin, hexythiazox, etoxazole, diafenthiuron, propargite, tetradifon, chlorofenapyr, DNOC, buprofezine, cyromazine, amitraz, hydramethylnon, acequinocyl, fluacrypyrim, rotenone, or the agriculturally acceptable salts and derivatives thereof.

Examples of suitable fungicides are compounds from the classes of the dinitroanilines, allylamines, anilinopyrimidines, antibiotic fungicides, aromatic hydrocarbons, benzenesulfonamides, benzimidazoles, benzisothiazoles, benzophenones, benzothiadiazoles, benzotriazines, benzyl carbamates, carbamates, carboxamides, carboxylic acid diamides, chloronitriles, cyanoacetamide oximes, cyanoimidazoles, cyclopropanecarboxamides, dicarboximides, dihydrodioxazines, dinitrophenyl crotonates, dithiocarbamates, dithiolanes, ethylphosphonates, ethylaminothiazolecarboxamides, guanidines, hydroxy(2-amino)pyrimidines, hydroxyanilides, imidazoles, imidazolinones, isobenzofuranones, methoxyacrylates, methoxycarbamates, morpholines, N-phenylcarbamates, oxazolidinediones, oximinoacetates, oximinoacetamides, peptidylpyrimidine nucleosides, phenylacetamides, phenylamides, phenylpyrroles, phenylureas, phosphonates, phosphorothioates, phthalamic acids, phthalimides, piperazines, piperidines, propionamides, pyridazinones, pyridines, pyridinylmethylbenzamides, pyrimidineamines, pyrimidines, pyrimidinone hydrazones, pyrroloquinolinones, quinazolinones, quinolines, quinones, sulfamides, sulfamoyltriazoles, thiazolecarboxamides, thiocarbamates, thiophanates, thiophenecarboxamides, toluamides, triphenyltin compounds, triazines, triazoles and the agriculturally acceptable salts and derivatives thereof.

Examples of suitable herbicides are compounds from the classes of the acetamides, amides, aryloxyphenoxypropionates, benzamides, benzofurans, benzoic acids, benzothiadiazinones, bipyridylium salts, carbamates, chloroacetamides, chlorocarboxylic acids, cyclohexanediones, dinitroanilines, dinitrophenols, diphenyl ethers, glycines, imidazolinones, isoxazoles, isoxazolidinones, nitriles, N-phenylphthalimides, oxadiazoles, oxazolidinediones, oxyacetamides, phenoxycarboxylic acids, phenyl carbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl (thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas and the agriculturally acceptable salts and derivatives thereof.

In a specific subgroup of this group of embodiments, the crop protecting agent is a crop protecting agent which is liquid at 22° C. and 1 bar or a mixture of two or more crop protecting agents which is liquid at 22° C. and 1 bar. Examples of room temperature liquid active ingredients are dimethenamid, especially the enantiomer thereof dimethenamid-P, clomazone, metolachlor, especially the enantiomer thereof S-metolachlor, alachlor and cinmethylin.

In a further specific subgroup of this group of embodiments, the crop protecting agent is a crop protecting agent or a mixture of crop protecting agents with low water solubility and a melting point of not more than 110° C. or a mixture of such active ingredients. These include, for example, pyrachlostrobin (64° C.), prochloraz (47° C.), metrafenon (100° C.), alphacypermethrin (79° C.) and pendimethalin (58° C.).

In yet a further specific subgroup of this group of embodiments, the crop protecting agent is a pheromone or a mixture of pheromones, optionally in combination with one or more attractants.

Pheromones are well known chemical compounds used for controlling undesired insects. For example, Metcalf, R. L. Ullmann's Encyclopedia of Industrial Chemistry 2000, keyword “Insect Control”, lists in Chapter 15.1 (Sex pheromone attractants) and Chapter 15.2 (Aggregation pheromones) suitable examples, wherein the pheromones for Lipidoptera in Table 4 of this reference are highly suitable.

Examples of pheromones include volatile alkanols and alkenols having from 5 to 18 carbon atoms, volatile alkanals and alkenals having from 5 to 18 carbon atoms, alkanones having from 6 to 18 carbon atoms, 1,7-dioxaspirononan and 3- or 4-hydroxy-1,7-dioxaspiroundecan, benzyl alcohol, Z-(9)-tricosene (muscalure), heneicosene, diacetyl, alcanoic acids having from 5 to 16 carbon atoms such as caprylic acid, laurylic acid, α-pinen, methyleugenol, ethyldodecanoate, tert-butyl 4-(or 5-)chloro-2-ethylcyclohexane-carboxylate, mycrenone, cucurbitacin, trimedlure (commercially available as Capilure®), and (E,E)-8,10-dodecadien-1-ol (codlemone).

Further examples of known pheromones are: Z-5-Decenyl acetate, dodecanyl acetate, Z-7-dodecenyl acetate, E-7-dodecenyl acetate, Z-8-dodecenyl acetate, E-8-dodecenyl acetate, Z-9-dodecenyl acetate, E-9-dodecenyl acetate, E-10-dodecenyl acetate, 11-dodecenyl acetate, Z-9,11-dodecadienyl acetate, E-9,11-dodecadienyl acetate, Z-11-tridecenyl acetate, E-11-tridecenyl acetate, tetradecenyl acetate, E-7-tetradecenyl acetate, Z-8-tetradecenyl acetate, E-8-tetradacenyl acetate, Z-9-tetradecenyl acetate, E-9-tetradecenyl acetate, Z-10-tetradecenyl acetate, E-10-tetradecenyl acetate, Z-11-tetradecenyl acetate, E-11-tetradecenyl acetate, Z-12-pentadecenyl acetate, E-12-pentadecenyl acetate, hexadecanyl acetate, Z-7-hexadecenyl acetate, Z-11-hexadecenyl acetate, E-11-hexadecenyl acetate, octadecanyl acetate, E,Z-7,9-dodecadienyl acetate, Z,E-7,9-dodecadienyl acetate, E,E-7,9-dodecadienyl acetate, Z,Z-7,9-dodecadienyl acetate, E,E-8,10-dodecadienyl acetate, E,Z-9,12-dodecadienyl acetate, E,Z-4,7-tri-decadienyl acetate, 4-methoxy-cinnamaldehyde, [beta]-ionone, estragol, eugenol, indole, 8-methyl-2-decyl propanoate, E,E-9,11-tetradecadienyl acetate, Z,Z-9,12-tetradecadienyl acetate, Z,Z-7,11-hexadecadienyl acetate, E,Z-7,11-hexadecadienyl acetate, Z,E-7,11-hexadecadienyl acetate, E,E-7,11-hexadecadienyl acetate, Z,E-3,13-octadecadienyl acetate, E,Z-3,13-octadecadienyl acetate, E,E-3,13-octadecadienyl acetate, hexanol, heptanol, octanol, decanol, Z-6-nonenol, E-6-nonenol, dodecanol, 11-dodecenol, Z-7-dodecenol, E-7-dodecenol, Z-8-dodecenol, E-8-dodecenol, E-9-dodecenol, Z-9-dodecenol, E-9,11-dodecadienol, Z-9,11-dodecadienol, Z,E-5,7-dodecadienol, E,E-5,7-dodecadienol, E,E-8,10-dodecadienol, E,Z-8,1 0-dodecadienol, Z,Z-8,10-dodecadienol, Z,E-8,10-dodecadienol, E,Z-7,9-dodecadienol, Z,Z-7,9-dodecadienol, E-5-tetradecenol, Z-8-tetradecenol, Z-9-tetradecenol, E-9-tetradecenol, Z-10-tetradecenol, Z-11-tetradecenol, E-11-tetradecenol, Z-11-hexadecenol, Z,E-9,11-tetradecadienol, Z,E-9,12-tetradecadienol, Z,Z-9,12-tetradecadienol, Z,Z-10,12-tetradecadienol, Z,Z-7,11-hexadecadienol, Z,E-7,11-hexadecadienol, (E)-14-methyl-8-hexadecen-1-ol, (Z)-14-methyl-8-hexadecen-1-ol, E,E-10,12-hexadecadienol, E,Z-10,12-hexadecadienol, dodecanal, Z-9-dodecenal, tetradecanal, Z-7-tetradecenal, Z-9-tetradecenal, Z-11-tetradecenal, E-11-tetradecenal, E-11,13-tetradecadienal, E,E-8,10-tetradecadienal, Z,E-9,11-tetradecadienal, Z,E-9,12-tetradecadienal, hexadecanal, Z-8-hexadecenal, Z-9-hexadecenal, Z-10-hexadecenal, E-10-hexadecenal, Z-11-hexadecenal, E-11-hexadecenal, Z-12-hexadecenal, Z-13-hexadecenal, (Z)-14-methyl-8-hexadecenal, (E)-14-methyl-8-hexadecenal, Z,Z-7,11-hexadecadienal, Z,E-7,11-hexadecadienal, Z,E-9,11-hexadecadienal, E,E-10,12-hexadecadienal, E,Z-10,12-hexadecadienal, Z,E-10,12-hexadecadienal, Z,Z-10,12-hexadecadienal, Z,Z-11,13-hexadecadienal, octadecanal, Z-11-octadecenal, E-13-octadecenal, Z-13-octadecenal, Z-5-decenyl-3-methyl butanoate disparlure: (+) cis-7,8-epoxy-2-methyloctadecane, seudenol: 3-methyl-2-cyclohexen-1-ol, sulcatol: 6-methyl-5-hepten-2-ol, ipsenol: 2-methyl-6-methylene-7-octen-4-ol, ipsdienol: 2-methyl-6-methylene-2,7-octadien-4-ol, grandlure I: cis-2-isopropenyl-1-methylcyclobutane-ethanol, grandlure II: Z-3,3-dimethyl-1-cyclohexane-ethanol, grandlure III: Z-3,3-dimethyl-1-cyclohexane-acetalde-hyde, grandlure IV: E-3,3-dimethyl-1-cyclohexaneacetaldehyde, cis-2-ver-benol: cis-4,6,6-trimethylbicyclo[3,1,1]hept-3-en-2-ol cucurbitacin, 2-methyl-3-buten-2-ol, 4-methyl-3-heptanol, cucurbitacin, 2-methyl-3-buten-2-ol, 4-methyl-3-heptanol, [alpha]-pinene: 2,6,6-trimethylbicyclo[3,1,1]hepten-2-ene, [alpha]-caryophyllene: 4,11,11-trimethyl-8-methylene-bicyclo[7,2,0]undecane, Z-9-tricosene, ([alpha]-multistriatin, 2-(2-endo,4-endo)-5-ethyl-2,4-dimethyl-6,8-dioxabicyclo[3,2,1]octane, methyleugenol: 1,2-dimethoxy-4-(2-propenyl)phenol, lineatin: 3,3,7-trimethyl-2,9-dioxatricyclo[3,3,1,0]nonane, chalcogran: 2-ethyl-1,6-dioxaspiro[4,4]nonane, frontalin: 1,5-dimethyl-6,8-dioxabicyclo[3,2,1]octane, endo-brevicomin: endo-7-ethyl-5-methyl-6,8-dioxabicyclo[3,2,1]octane, exo-brevicomin: exo-7-ethyl-5-methyl-6,8-dioxabicyclo[3,2,1]octane, (Z)-5-(1-decenyl)dihydro-2-(3H)-furanone, farnesol: 3,7,11-trimethyl-2,6,10-dodecatrien-1-ol, nerolidol 3,7-11-trimethyl-1,6,10-dodecatrien-3-ol, 3-methyl,6-(1-methylethenyl)-9-decen-1-ol acetate, (Z)-3-methyl-6-(1-methylethenyl)-3,9-decadien-1-ol acetate, (E)-3,9-methyl-6-(1-methyl-ethenyl)-5,8-decadien-1-ol acetate, 3-methylene-7-methyl-octen-1-ol propionate, (Z)-3,7-dimethyl-2,7-octadien-1-ol propionate and (Z)-3,9-dimethyl-6-(1-methyl-ethenyl)-3,9-decadlien-1-ol propionate.

Preferred pheromones are Z-9-dodecenyl acetate (commercially available as RAK® 1 from BASF SE), (E7,Z9)-dodecadienly acetate (commercially available as RAK® 2 from BASF SE), (E,E)-8,10-dodecadien-1-ol (commercially available as RAK® 3 from BASF SE) and Z-8-dodecenyl acetate.

Particularly preferred pheromone comprises (E,E)-8,10-dodecadien-1-ol, which is also known as codlemone or codlure, and commercially available (e.g. as CheckMate® CM-F from Suterra LLC, USA, Isomate®-C Plus from Pacific Biocontrol Corp. USA; RAK® 3 from BASF SE). Codlemone may be used in pure form, in technical quality or mixed with other pheromones.

The aforementioned pheromones may be combined with one or more attractants. Attractants are non-pesticidal materials which may act in one or several of the following ways: a) entice the insect to approach the composition or the material treated with the composition; b) entice the insect to touch the composition or the material treated with the composition; c) entice the insect to consume the composition or the material treated with the composition; and d) entice the insect to return to the composition or the material treated with the composition. Suitable attractants include non-food attractants and food attractants, also termed as feeding stimulants.

Suitable non-food attractants are usually volatile material. The volatile attractants act as a lure and their type will depend on the pest to be controlled in a known manner. Non-food attractants include for example flavors of natural or synthetic origin. Suitable flavors include meat flavor, yeast flavor, seafood flavor, milk flavor, butter flavor, cheese flavor, onion flavor, and fruit flavors such as flavors of apple, apricot, banana, blackberry, cherry, currant, gooseberry, grape, grapefruit, raspberry and strawberry.

Suitable food attractants include:
proteins, including animal proteins and plant proteins, e. g. in the form meat meal, fish meal, fish extracts, seafood, seafood extracts, or blood meal, insect parts, crickets powder, yeast extracts, egg yolk, protein hydrolysates, yeast autolysates, gluten hydrolysates, and the like;
carbohydrates and hydrogenated carbohydrates, in particular mono- and disaccharides such glucose, arabinose, fructose, mannose, sucrose, lactose, galactose, maltose, maltotriose, maltotetrose, maltopentose or mixtures thereof such as molasses, corn syrup, maple syrup, invert sugars, and honey; polysaccharides including starch such as potato starch, corn starch, and starch based materials such as cereal powders (e.g. wheat powder, maize powder, malt powder, rice powder, rice bran), pectines, and glycerol, hydrogenated mono- and oligosaccharides (sugar alcohols) such as xylitol, sorbitol, mannitol, isomaltolose, trehalose and maltitol as well as maltitol containing syrups;

Preferred attractants are ethyl 3-methylbutanoate, methyl salicylate, amyl acetate, limonene or fruit extracts (e.g. apple extracts made from dried and extracted apples, comprises fructose, glucose, sorbitol, and the flavor of apples). Mixtures of attractants are also suitable.

In a further group of embodiments, the organic active is an organic active suitable for cosmetic applications or an active mixture other than the aforementioned aromas. Preferred cosmetic actives for loading of the microparticles are especially active plant ingredients and plant extracts.

Examples of cosmetic actives are skin and hair pigmentation agents, tanning agents, bleaches, keratin-hardening substances, antimicrobial active ingredients, photofilter active ingredients, repellent active ingredients, hyperemic substances, keratolytic and keratoplastic substances, antidandruff active ingredients, antiphlogistics, keratinizing substances, antioxidative active ingredients and active ingredients acting as free-radical scavengers, skin moisturizing or humectant substances, regreasing active ingredients, deodorizing active ingredients, sebostatic active ingredients, plant extracts, antierythematous or antiallergic active ingredients and mixtures thereof.

Artificial tanning actives suitable for tanning the skin without natural or artificial irradiation with UV rays are, for example, dihydroxyacetone, alloxan and walnut shell extract. Suitable keratin-hardening substances are generally active ingredients as are also used in antiperspirants, for example potassium aluminum sulfate, aluminum hydroxychloride, aluminum lactate, etc. Antimicrobial active ingredients are used to destroy microorganisms and/or to inhibit their growth and thus serve both as preservatives and also as a deodorizing substance which reduces the formation or the intensity of body odor. These include, for example, customary preservatives known to the person skilled in the art, such as p-hydroxybenzoic esters, imidazolidinylurea, formaldehyde, sorbic acid, benzoic acid, salicylic acid, etc. Such deodorizing substances are, for example, zinc ricinoleate, triclosan, undecylenoic acid alkylolamides, triethyl citrate, chlorhexidine, etc. Suitable photofilter active ingredients are substances, which absorb UV rays in the UV-B and/or UV-A region. Suitable UV filters are those mentioned above. Additionally suitable are p-aminobenzoic esters, cinnamic esters, benzophenones and camphor derivatives, and pigments, which stop UV rays, such as titanium dioxide, talc and zinc oxide. Suitable repellent active ingredients are compounds capable of warding off or driving away certain animals, particularly insects, from humans. These include, for example, 2-ethyl-1,3-hexanediol, N,N-diethyl-m-toluamide, etc. Suitable hyperemic substances, which stimulate blood flow through the skin, are, for example, essential oils, such as dwarf pine, lavender, rosemary, juniper berry, roast chestnut extract, birch leaf extract, hayseed extract, ethyl acetate, camphor, menthol, peppermint oil, rosemary extract, Eucalyptus oil, etc. Suitable keratolytic and keratoplastic substances are, for example, salicylic acid, calcium thioglycolate, thioglycolic acid and its salts, sulfur, etc. Suitable antidandruff active ingredients are, for example, sulfur, sulfur polyethylene glycol sorbitan monooleate, sulfur ricinol polyethoxylate, zinc pyrithione, aluminum pyrithione, etc. Suitable antiphlogistics, which counter skin irritations, are, for example, allantoin, bisabolol, Dragosantol, chamomile extract, panthenol, etc.

Further cosmetic actives are aspalatin, glycyrrhizin, caffeine, proanthocyanidin, hesperetin, rutin, luteolin, polyphenols, oleuropein, theobromine, bioflavonoids and polyphenols.

Examples of plant extracts are also acai extract (Euterpe oleracea), acerola extract (Malpighia glabra), field horsetail extract (Equisetum arvense), Agarius extract (Agarius blazei murill), Aloe extract (Aloe vera, Aloe barbadensis), apple extract (Malus), artichoke leaf extract (Cynara scolymus), artichoke blossom extract (Cynara edulis), Arnica extract (Arnica Montana), oyster extract (Ostrea edulis), baldrian root extract (Valeriana officinalis), bearberry leaf extract (Arctostaphylos uva-ursi), bamboo extract (Bambus vulgaris), bitter melon extract (Momordica charantia), bitter orange extract (Citrus aurantium), nettle leaf extract (Urtica dioica), nettle root extract (Urtica dioica), broccoli extract (Brassica oleracea), watercress extract (Rorippa nasturtium), painted nettle extract (Coleus forskohlii), Capsicum extract (Capsicum frutescens), extract from Centella asiatica (Gotu Kola), cinchona extract, cranberry extract (Vaccinium vitis-daea), turmeric extract (Curcuma longa), damiana extract (Tunera diffusa), dragonfruit extract (Pitahaya), extract from Echinacea purpurea, wheat placenta extract, edelweiss extract (Leotopodium alpinum), ivy extract (Hedera helix), bindii extract (Tribulus terrestris), Garcinia cambogia extract (Garcinia cambogia), Ginkgo extract (Ginkgo biloba), Ginseng extract (Panax ginseng), pomegranate extract (Punica granatum), grapefruit extract (Citrus paradisi), Griffonia extract (Griffonia simplicifolia), green tea extract (Camellia sinensis), guarana extract (Paullinia cupana), cucumber extract (Cucumis sativus), dog rose extract (Rosa canina), blueberry extract (Vaccinium myrtillus), hibiscus extract (malvacea), mallow extract, honey extract, hops extract (Humulus), ginger extract (Zingiber officinale), Iceland moss extract (Cetraria islandica), jojoba extract (Simmondsia chinensis), St. John's Wort extract (Hypericum perforatum), coffee concentrate, cocoa bean extract (Theobroma cacao), cactus blossom extract, chamomile blossom extract (Matricaria recutita, Matricaria chamomila), carrot extract (Daucus carota), kiwi extract (Aperygidae), kudzu extract (Pueraria lobata), coconut milk extract, pumpkinseed extract (Curcurbita pepo), cornflower extract (Centaurea cyanus), lotus flower extract, dandelion extract (Taraxacum officinale), maca extract (Lepidium peruvianum), Magnolia blossom extract, mango extracts, milk thistle extract (Silybum marianum), marigold extract (Calendula officiennalis), mate extract (Hex paraguariensis), butcher's broom extract (Rugcus aculeatus), sea algae extracts, cranberry extracts (Vaccinium macrocarpon), Moringa Oleifera extract, extract from Moschus Malve (Malva moschata), evening primrose oil extract (Azadirachta indica), nettle extract (Urticaceae), olive leaf extract (Olea europea), orange extract (hesperidin), orchid extract, papaya extract (Carica papaya), peppermint extracts, extract from Carica papaya (Geissospermum), bitter orange extract (Citrus aurantioum), lingonberry extract (Vaccinium vitas-ideea), African cherry extract (Prunus africana), sugar beet extracts, resveratrole extract (Polygonum cuspidatum), rooibos extract (Aspalasthus linnearis), rose blossom extract, horse chestnut extract (Aesculus hippocastanum), rosemary extract (Rosemarinus officinalis), red clover extract (Trifolium platense), red wine extract (Vitis vinifera), saw palmetto extract (Serenoa repens), lettuce extract (Lactuca sativa), sandalwood extract (Santalum rubrum), sage extract (Salvia officinalis), horsetail extract (Equisetum), yarrow extract (Achillea millefolium), black pepper extract (Piper nigrum), black tea extract, waterlily extract (Nymphaea), white willow bark extract (Salix Alba), liquorice extract (Glycyrrhiza), devil's claw extract (Harpagophytum procumbens), thyme extract (Thymus vulgaris), tomato extract (Lycopersicum esculentum), grapeseed extract (Vitis vinifera), grapeskin extract (Vitis vinifera), watercress (Rorippa amphibia), willow bark extract (Salix alba), wormwood extract (Artemisia absinthium), white tea extract, yam root extract (Dioscorea opposita), yohimbe extract (Pausinystalia yohimbe), witch hazel extract (Hamamelis), cinnamon extract (Cinnamomum cassia Presl), lemon extract (Citrus) and onion extract (Allium cepa).

In a further group of embodiments, the organic active of low molecular weight is a vitamin, in particular a lipophilic vitamin, such as vitamin A, vitamin D, vitamin E or vitamin K or a combination thereof.

In a further group of embodiments, the organic active of low molecular weight is an organic effect compound. Effect compounds are organic actives, which do not belong to agrochemicals, aromachemicals, vitamins, AIPs and cosmetic actives. The groups of effect compounds are typically not admitted for use in agriculture, for administration to human beings, for cosmetic or dietary purposes. They include but are not limited to compounds for construction chemistry, in particular catalysts, but also dyes, UV stabilizers, polymerization inhibitors, oxidation stabilizers and the like. Preferred actives for being encapsulated into the microparticles for applications in construction chemistry are especially polymerization catalysts.

Useful polymerization catalysts include those suitable for curing of reactive resins, especially addition resins, condensation resins or oxidation-curing resins. For this purpose, the polymerization catalyst is a catalyst for a free-radical polymerization, a polycondensation and/or a polyaddition. The suitable catalysts for a free-radical polymerization especially include peroxide splitters, and the catalysts known from coatings technology for oxidatively drying oil and alkyd resins as driers or siccatives. Suitable polycondensation catalysts are catalysts for silicone condensation and crosslinking. Polyaddition catalysts used may, for example, be catalysts for curing of epoxy resins. In addition, polyaddition catalysts used may, for example, be urethanization catalysts customarily used in polyurethane chemistry. These are compounds that accelerate the reaction of the reactive hydrogen atoms of isocyanate-reactive components with the organic polyisocyanates.

Useful polymerization catalysts especially include tertiary amines, phosphines and organic metal salts.

Tertiary amines useful as polymerization catalysts, especially for polyadditions, are e. g. triethylamine, tributylamine, N,N-dimethylcyclohexylamine (DMCHA), N-methyldicyclohexylamine, N,N-dimethylbenzylamine (BDMA), N-methylmorpholine, N-ethylmorpholine, N-cyclohexylmorpholine, 2,2′-dimorpholinodiethyl ether (DMDEE), N,N,N′,N′-tetramethylethylenediamine, N,N,N′,N′-tetramethylbutylene-diamine, N,N,N′,N′-tetramethylhexylene-1,6-diamine, N,N,N′,N″,N″-pentamethyl-diethylenetriamine (PMDETA), N,N,N′,N″,N″-pentamethyldipropylenetriamine (PMDPTA), N,N,N-tris(3-dimethylaminopropyl)amine, bis(2-dimethylaminoethyl) ether (BDMAEE), bis(dimethylaminopropyl)urea, 2,4,6-tris(dimethylaminomethyl)phenol, and its salt with 2-ethylhexanoic acid and isomers thereof, 1,4-dimethylpiperazine (DMP), N-methylimidazole, 1,2-dimethylimidazole, 1-methyl-4-(2-dimethylaminoethyl) piperazine, 1-azabicyclo[3.3.0]octane, 1,4-diazabicyclo[2.2.2]octane (DABCO), 1,8-diazabicyclo[5.4.0]undec-7-ene (DBU), 1,5-diazabicyclo[4.3.0]non-7-ene (DBN).

Further useful polymerization catalysts, especially for polyadditions, include: tris(dialkylamino)-s-hexahydrotriazines, especially 1,3,5-tris(3-[dimethylamino]propyl) hexahydrotriazine.

Useful phosphines as polymerization catalysts, especially for polyadditions, are preferably tertiary phosphines, such as triphenylphosphine or methyldiphenyl-phosphine.

Organic metal salts useful as polymerization catalysts preferably have the general formula

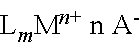

in which
the ligand L is an organic radical or an organic compound selected from alkyl, alkenyl, alkynyl, aryl, arylalkyl, alkylaryl, heteroaryl, heteroarylalkyl, alkylheteroaryl and acyl, the ligand L having 1 to 20 carbon atoms, and the m ligands L being the same or different,
m is 0, 1, 2, 3, 4, 5 or 6,
M is a metal,
n is 1, 2, 3 or 4, and
the anion A⁻ is a carboxylate ion, alkoxylate ion or enolate ion.

The metal M is preferably selected from lithium, potassium, cesium, magnesium, calcium, strontium, barium, boron, aluminum, indium, tin, lead, bismuth, cerium, cobalt, iron, copper, lanthanum, manganese, mercury, scandium, titanium, zinc and zirconium; more particularly from lithium, potassium, cesium, tin, bismuth, titanium, zinc and zirconium.

The ligand L is preferably alkyl having 1 to 20 carbon atoms. More preferably, L is alkyl having 1 to 10 carbon atoms, especially 1 to 4 carbon atoms, e.g. methyl, ethyl, n-propyl, isopropyl, n-butyl, isobutyl, sec-butyl or tert-butyl.

The carboxylate ion preferably has the formula R¹—COO—, where R¹ is selected from H, alkyl, alkenyl, alkynyl, aryl, arylalkyl, alkylaryl, heteroaryl, heteroarylalkyl, alkylheteroaryl and acyl, and where the R¹ radical has up to 20 carbon atoms, preferably 6 to 20 carbon atoms. Particularly preferred carboxylate ions are selected from the anions of natural and synthetic fatty acids, such as neodecanoate, isooctanoate and laurate, and the anions of resin acids and naphthenic acids.

The enolate ion preferably has the formula R²CH═CR³—O— where R² and R³ are each selected from H, alkyl, alkenyl, alkynyl, aryl, arylalkyl, alkylaryl, heteroaryl, hetero-arylalkyl, alkylheteroaryl and acyl, and where the R² and R³ radicals each have up to carbon atoms. Specific examples are ethylacetonate, heptylacetonate or phenyl-acetonate. The enolate ion derives preferably from a 1,3-diketone having five to eight carbon atoms. Possible examples include acetylacetonate, the enolate of 2,4-hexanedione, the enolate of 3,5-heptanedione and the enolate of 3,5-octanedione.

The alkoxylate ion preferably has the formula R⁴—O—, where R⁴ is selected from alkyl, alkenyl, alkynyl, aryl, arylalkyl, alkylaryl, heteroaryl, heteroarylalkyl, alkylheteroaryl and acyl, and where the R⁴ radical has up to 20 carbon atoms.

In particular embodiments, the organic metal compound is selected from
alkali metal carboxylates, such as lithium ethylhexanoate, lithium neodecanoate, potassium acetate, potassium ethylhexanoate, cesium ethylhexanoate;
alkaline earth metal carboxylates, such as calcium ethylhexanoate, calcium naphthenate, calcium octoate (available as Octa-Soligen® Calcium from OMG Borchers), magnesium stearate, strontium ethylhexanoate, barium ethylhexanoate, barium naphthenate, barium neodecanoate;
aluminum compounds, such as aluminum acetylacetonate, aluminum dionate (e.g. K KAT® 5218 from King Industries);
zinc compounds, for example zinc(II) diacetate, zinc(II) ethylhexanoate and zinc(II) octoate, zinc neodecanoate, zinc acetylacetonate;
tin compounds, such as tin(II) carboxylates, examples being tin(II) acetate, tin(II) octoate, tin(II) ethylhexanoate, tin(II) neodecanoate, tin(II) isononanoate, tin(II) laurate, and dialkyltin(IV) salts of organic carboxylic acids, examples being dimethyltin diacetate, dibutyltin diacetate, dibutyltin dibutyrate, dibutyltin bis(2-ethylhexanoate), dibutyltin dilaurate, dibutyltin maleate, dioctyltin dilaurate and dioctyltin diacetate, especially dibutyltin dilaurate;
titanium compounds, such as tetra(2-ethylhexyl) titanate;
zirconium compounds, such as zirconium ethylhexanoate, zirconium neodecanoate, zirconium acetylacetonate (e.g. K-KAT® 4205 from King Industries); zirconium dionates (e.g. K-KAT® XC-9213; XC-A 209 and XC-6212 from King Industries); zirconium 2,2,6,6-tetramethyl-3,5-heptanedionate;
bismuth compounds, such as bismuth carboxylates, especially bismuth octoate, bismuth ethylhexanoate, bismuth neodecanoate or bismuth pivalate (e.g. K-KAT® 348, XC-B221, XC-C227, XC 8203, XK 651 from King Industries, TIB KAT 716, 716LA, 716XLA, 718, 720, 789 from TIB Chemicals, and those from Shepherd Lausanne);
manganese salts, such as manganese neodecanoate, manganese naphthenate;
cobalt salts, such as cobalt neodecanoate, cobalt ethylhexanoate, cobalt naphthenate;
iron salts, such as iron ethylhexanoate;
mercury compounds, such as phenylmercury carboxylate.

Preferred organic metal compounds are dibutyltin dilaurate, dioctyltin dilaurate, zinc(II) diacetate, zinc(II) dioctoate, zirconium acetylacetonate and zirconium 2,2,6,6-tetramethyl-3,5-heptanedionate, bismuth neodecanoate, bismuth dioctoate and bismuth ethylhexanoate.

In a preferred group of embodiments, the aqueous emulsion is an oil in water emulsion (o/w emulsion) of a water-immiscible liquid, wherein the water-immiscible liquid comprises at least one organic active compound, which is preferably a pesticide.

An oil-in-water (o/w) emulsion is particularly preferred, where the droplets of the o/w emulsion are formed by the water-immiscible liquid, which are surrounded by at least one conjugate as defined herein.

Suitable water-immiscible liquids (water-immiscible solvents) for dissolving the organic active compounds are principally any organic solvent or solvent mixture, which has a solubility in deionized water of not more than than 50 g/l or not more than 20 g/l, in particular not more than 10 g/l.

Suitable water-immiscible liquids (water-immiscible solvents) for dissolving the organic active compounds, in particular pesticides, are in particular hydrocarbon solvents having a boiling point of at least 100° C., C₁-C₈-alkyl esters of C₈-C₂₆-fatty acids, mono- and di-C₁-C₄-alkyl amides of C₈-C₂₆-fatty acids, N—C₅-C₁₈-alkyl pyrrolidones and mixtures thereof. Among these, solvents and solvent mixtures are preferred, which are liquid at 20° C.

In this context “liquid” means that the diluent has, under standard conditions, a dynamic viscosity at 20° C. of, as a rule, no more than 150 mPa·s, in particular no more than 100 mPa·s, specifically no more than 50 mPa·s, in particular in the range of from 1 to 150 mPa·s, preferably in the range of from 2 to 100 mPa·s and in particular in the range of from 3 to 50 mPa·s (determined as specified in ASTM D 445).

In this context aliphatic hydrocarbon solvents with a boiling point of at least 100° C. particularly refer to saturated and unsaturated hydrocarbons that may optionally include a non-aromatic carbocycle, such as linear, branched and cyclic alkanes and alkenes, that have boiling points in the stated range and include 7 to about 18 carbon atoms, and in particular also to mixtures of these aliphatic hydrocarbons.

Such mixtures are commercially available e.g. under the trade name Exxsol which denotes products that predominantly contain kerosene having been depleted of aromatic components, such as Exxsol™ D30, Exxsol™ D40, Exxsol™ D80, Exxsol™ D100, Exxsol™ D120 and Exxsol™ D220/230. An example of an aliphatic hydrocarbon having a carbocycle is limonene.

In the context of the invention aromatic hydrocarbon solvents with a boiling point of at least 100° C. particularly refer to mono- or polycyclic aromatic compounds which optionally may carry one or more aliphatic or araliphatic substituents, in particular alkyl and arylalkyl moieties, and which have boiling points in the stated range. Said aromatic hydrocarbon solvents preferably refer to mixtures of such aromatic compounds that are obtained by distillation in particular from crude oil products as fractions in the given boiling point range, such as the commercial products known under the trade names Solvesso®, in particular Solvesso® 100, Solvesso® 150, Solvesso® 200, Solvesso® 150 ND and Solvesso® 200 ND, Aromatic®, in particular Aromatic® 150 and Aromatic® 200, Hydrosol®, in particular Hydrosol® A 200 and Hydrosol® A 230/270, Caromax®, in particular Caromax® 20 and Caromax® 28, Aromat K 150, Aromat K 200, Shellsol®, in particular Shellsol® A 100 and Shellsol® A 150, and Fin FAS-TX, in particular Fin FAS-TX 150 und Fin FAS-TX 200. Particularly preferred are the mixtures Solvesso® 150 ND and Solvesso® 200 ND (ExxonMobil Chemical), which are depleted of the potential carcinogen naphthalene. Thus, Solvesso® 150 ND mainly contains aromatic hydrocarbons having 10 or 11 carbon atoms, which boil in the range of from 175 to 209° C. and primarily consist of alkylbenzenes, whereas Solvesso® 200 ND mainly contains aromatic hydrocarbons having 10 to 14 carbon atoms which boil in the range of from 235 to 305° C. and primarily consist of alkylnaphthalenes.

Another example for said aromatic hydrocarbon solvents is a product known under its tradename Hisol SAS-296 that consists of a mixture of 1-phenyl-1-xylylethane and 1-phenyl-1-ethylphenylethane.

In the context of C₁-C₈-alkyl esters of C₈-C₂₆-fatty acids and mono- and di-C₁-C₄-alkyl amides of C₈-C₂₆-fatty acids the term “C₈-C₂₆-fatty acid” refers to a fatty acid or a mixture of fatty acids having from 8 to 26 carbon atoms. Examples of C₁-C₂₆-fatty acids are the saturated fatty acids caprylic acid, caprinic acid, lauric acid, myristic acid, palmitic acid, margaric acid, stearic acid, arachidic acid, behenic acid, lignoceric acid and cerotic acid; the mono-unsaturated fatty acids undecylenic acid, palmitoleic acid, oleic acid, elaidic acid, vaccenic acid, eicosenic acid, cetoleic acid, erucic acid and nervonic acid; and the poly-unsaturated fatty acids linoleic acid, linolenic acid, arachidonic acid, timnodonic acid, clupanodonic acid and cervonic acid.

Amongst the C₁-C₈-alkyl esters of C₈-C₂₆-fatty acids preference is given to the C₁-C₄-alkyl esters, in particular to the C₁-C₄-alkyl esters of C₁₂-C₂₂-fatty acids, especially to the methyl esters and the ethyl esters of C₁₂-C₂₂-fatty acids. Preference is given to C₁-C₄-alkyl esters of C₁₂-C₂₂-fatty acids, wherein the total amount of saturated or mono-unsaturated C₁₂-C₂₂-fatty acids is at least 80% by weight, based on the total weight of fatty acid in the fatty acid esters. In particular, the C₁-C₈-alkyl esters of C₈-C₂₆-fatty acids are methylated or ethylated plant oils, i. e. products obtained by transesterification of a plant oil with methanol or ethanol.

Amongst the mono- and di-C₁-C₄-alkyl amides of C₈-C₂₆-fatty acids, preference is given to the mono- and di-C₁-C₄-alkyl amides of C₁₂-C₂₂-fatty acids, in particular the mono-methyl amides, mono-ethyl amides, dimethyl amides and diethyl amides thereof. Particular preference is given to the mono- and di-C₁-C₂-alkyl amides of C₁₂-C₂₂-fatty acids, wherein the total amount of saturated or mono-unsaturated C₁₂-C₂₂-fatty acids is at least 80% by weight, based on the total weight of fatty acid in the mono- and di-C₁-C₂-alkyl amides of C₁₂-C₂₂-fatty acids. A mixture of methyl esters of saturated and mono-unsaturated C₁₄-C₁₈-fatty acids is commercially available e.g. under the trade name Synative™ ES ME TI 05 (Cognis).

Examples of N-C₅-C₁₈-alkyl pyrrolidone are N-methyl pyrrolidone, N-ethyl pyrrolidone, N-propyl pyrrolidone, N-isopropyl pyrrolidone, N-butyl pyrrolidone, N-isobutyl pyrrolidone, N-pentyl pyrrolidone, N-hexyl pyrrolidone, N-(4-ethyl-pentyl) pyrrolidone, N-octyl pyrrolidone, N-2-ethylhexyl pyrrolidone, N-nonyl pyrrolidone, N-decyl pyrrolidone and N-(7-methyl-decyl) pyrrolidone, n-dodecyl pyrrolidone and N-tetradecyl pyrrolidone

The inventive aqueous composition containing at least one agrochemical, in particular pesticide is particularly suitable for controlling plant pathogenic organisms or for controlling the growth of plants. Therefore, the use of the inventive aqueous composition containing at least one agrochemical, in particular pesticide is particularly preferred for controlling plant pathogenic organisms or for controlling the growth of plants.

In the aqueous compositions of the invention, the relative amount of the conjugate is generally in the range of 1 to 50% by weight, in particular in the range of 2 to 40% by weight, more particularly in the range of 3 to 35% by weight and especially in the range of 5 to 30% by weight, based on the weight of the water immiscible liquid.

In a particular group of embodiments, the aqueous composition is an aqueous oil-in-water emulsion (o/w emulsion). In the o/w emulsion, the amount of the oil phase may be in the range of 0.1 to 60% by weight, in particular in the range of 1 to 50% by weight, especially in the range of 1.5 to 40% by weight, based on the total weight of the emulsion.

The conjugates of present invention may also be used in applications, where the stabilization of aqueous emulsion, in particular oil-in-water emulsions, and/or the stabilization of greasy soil are required. Therefore, the conjugates of present invention can also be used as a surfactant in surfactant containing compositions, such as washing and cleaning compositions, including liquid and solid laundry detergents, in dishwashing detergents, including machine dishwashing compositions and hand dishwashing agents, in cleaner compositions (cleaners), such as household cleaners and industrial cleaners and hard surface cleaners. In these compositions, the conjugates may replace a portion of the conventional surfactants contained therein and thus improve the ecological compatibility of these compositions.

### EXAMPLES

The invention is elucidated in more detail by the examples hereinafter.

### Materials:

CT-COOH: 5-((3,7-dimethyloct-6-en-1-yl)oxy)-5-oxopentanoic acid
MT-COOH: 5-((2-isopropyl-5-methylcyclohexyl)oxy)-5-oxopentanoic acid
THG-COOH: 5-((3,7-dimethyloctyl)oxy)-5-oxopentanoic acid
Citropol® H: Polycitrinellol. 6-octen-1-ol, 3,7-dimethyl-, homopolymer. CAS=888224-71-3. P2 Science
Novozyme 435: Immobilized lipase. Novozymes
Dextran 4: anhydroglucose. CAS=9004-54-0. Serva Electrophoresis GmbH
Dextran-NH₂: reaction product between dextran 4 and hexylenediamine
DMSO: Dimethyl sulfoxide. CAS=67-68-5
THF: Tetrahydrofuran. CAS=109-99-9
Cinmethylin: exo-(t)-1-Methyl-2-(2-methylbenzyloxy)-4-isopropyl-7-oxa-bicyclo[2.2.1]heptane. BASF
Xanthan gum: xanthan gum, Rhodopol® G, Solvay S.A.

### Syntheses

### (1) Synthesis of Terpene Derivatives

### Example 1

### Synthesis of 5-((3,7-dimethyloct-6-en-1-yl)oxy)-5-oxopentanoic acid (CT-COOH)

The synthesis was done in two steps: esterification (i) followed by transesterification (ii).
(i) Esterification: In a 25 mL round-bottom flask equipped with a magnetic stirrer were added glutaric acid (1.00 g, 7.57 mmol), citronellol (2.36 g, 15.14 mmol), Novozyme 435 (0.169 g) and 8 mL of 2-methylbutan-2-ol solvent. The flask was sealed and the reaction mixture was stirred (170 rpm) at 40° C. for 6 h that resulted in formation of bis(3,7-dimethyloct-6-en-1-yl) glutarate. After completion of reaction, the mixture was filtered, and solvent was evaporated under rotary evaporator that gave 1.86 g of bis(3,7-dimethyloct-6-en-1-yl) glutarate.
(ii) Transesterification: In a 25 mL round-bottom flask equipped with a magnetic stirrer were added glutaric acid (2.00 g, 15.14 mmol), bis(3,7-dimethyloct-6-en-1-yl) glutarate (6.19 g, 15.14 mmol) and few drops of concentrated H₂SO₄ (catalytic amount). The flask was sealed and the reaction mixture was stirred at 100° C. overnight. The mono ester was purified with column chromatography using a mixture of hexane:ethyl acetate (90:10) as mobile phase. 3.32 g of trans-esterified monoester 5-((3,7-dimethyloct-6-en-1-yl)oxy)-5-oxopentanoic acid (CT-COOH) was obtained.

### Example 2

### Synthesis of 5-((2-isopropyl-5-methylcyclohexyl)oxy)-5-oxopentanoic acid (MT-COOH)

The same two step procedure as Example 1 was used to manufacture 5-((2-isopropyl-5-methylcyclohexyl)oxy)-5-oxopentanoic acid.
(i) Esterification: menthol (2.36 g, 15.14 mmol) was used instead of citronellol and 1.92 g of bis(2-isopropyl-5-methylcyclohexyl) glutarate was obtained.
(ii) Transesterification: bis(2-isopropyl-5-methylcyclohexyl) glutarate (6.19 g, 15.14 mmol) was used instead of bis(3,7-dimethyloct-6-en-1-yl) glutarate and 1.98 g of 5-((2-isopropyl-5-methylcyclohexyl)oxy)-5-oxopentanoic acid (MT-COOH) was obtained.

### Example 3: Synthesis of 5-((3,7-dimethyloctyl)oxy)-5-oxopentanoic acid (THG-COOH)

The same two step procedure as Example 1 was used to manufacture 5-((2-isopropyl-5-methylcyclohexyl)oxy)-5-oxopentanoic acid.
(i) Esterification: tetrahydrogeraniol (2.40 g, 15.14 mmol) was used instead of citronellol and 2.01 g of bis(3,7-dimethyloctyl) glutarate was obtained.
(ii) Transesterification: bis(3,7-dimethyloctyl) glutarate (6.25 g, 15.14 mmol) was used instead of bis(3,7-dimethyloct-6-en-1-yl) glutarate and 2.02 g of 5-((3,7-dimethyloctyl)oxy)-5-oxopentanoic acid (THG-COOH) was obtained.

### Example 4: Synthesis of Citropol-COOH

In a 250 mL round-bottom flask equipped with a magnetic stirrer were added 21.12 g glutaric, 10 g of Citropol® H, 1.55 g Novozyme 435, 20 g of dry molecular sieve and 45 mL of 2-methylbutan-2-ol solvent. The flask was sealed and the reaction mixture was stirred (170 rpm) at 40° C. for 16 h that resulted in formation of Citropol-COOH. After completion of reaction, the mixture was filtered, and solvent was evaporated under rotary evaporator. Then the crude mixture was dissolved in 100 mL and added dropwise into 600 mL of water that give a phase separation of the desired material layer. The oily phase was dried over sodium sulfate and evaporated to generate 7.5 g of Citropol-COOH.

(2) Modification of Dextran with Terpene Derivatives

### Example 5: Synthesis of Dextran-Graft-Citronellol

In a 10 mL round-bottom flask equipped with a magnetic stirrer were added Dextran 4 (0.25 g), CT-COOH (0.25 g, 9.2×10-4 mol), 3 mL of dried DMSO. The mixture was stirred to obtain a homogenous solution. Then Novozyme 435 (0.125 g) and dry molecular sieves (1.0 g) were added and the flask was sealed. The reaction mixture was warmed stirred at 40° C. for 24 h under stirring (170 rpm). After reaction, the modified dextran was precipitated three times into acetone to eliminate free terpene. 0.16 g of dextran-graft-citronellol amphiphilic polymer was recovered as a powder after drying process.

### Example 6: Synthesis of Dextran-Graft-Menthol

The same procedure as example 5 was used to produce dextran-graft-menthol Only the differences in term of raw material or quantity used are listed here. MT-COOH (0.50 g, 1.85 mmol) was used instead of CT-COOH. 5 mL of dried DMSO, 0.625 g of Novozyme 435 and 3 g of dry molecular sieve were added. 0.20 g of dextran-graft-menthol polymer was recovered as a powder after drying process. The biodegradation of the compound was evaluated in soil under the ISO 17556 norm using sandy soil Lihof C15. The percentages of biodegradation were determined by evolution of the CO₂ generated during the mineralization. After 28 days and 90 days, 72% and 85% of biodegradation were found, respectively.

### Example 7: Synthesis of Dextran-Graft-Citropol

In a 25 mL round-bottom flask equipped with a magnetic stirrer were added Dextran 4 (0.40 g), Citropol-COOH (example 4, 0.80 g), 10 mL of dried DMSO. The mixture was stirred to obtain a homogenous solution. Then Novozyme 435 (0.30 g) and dry molecular sieves (1.60 g) were added and the flask was sealed. The reaction mixture was warmed stirred at 40° C. for 24 h under stirring (170 rpm). After reaction, the modified dextran was precipitated three times into methanol to eliminate unreacted Citropol derivative. 0.34 g of dextran-graft-Citropol amphiphilic polymer was recovered as a waxy solid after drying process.

The biodegradation of the compound was evaluated in soil under the ISO 17556 norm using sandy soil Lihof C15. The percentages of biodegradation were determined by evolution of the CO₂ generated during the mineralization. After 28 days and 90 days, 59% and 75% of biodegradation were found, respectively.

### Example 8: Synthesis of Dextran-Block-Citropol

The synthesis was done in two steps: amination (i) followed by amidification (ii).
(i) Amination: In a 10 mL round-bottom flask equipped with a magnetic stirrer were added Dextran 4 (1.00 g), hexylenediamine (112 g, 9.63 mmol) and 2 mL of water. The mixture was stirred for 2 hours. After then, sodium cyanoborohydride (0.125 g, 1.99 mmol) was added.

The flask was sealed and the reaction mixture was stirred (170 rpm) at room temperature overnight. The medium was precipitated in acetone two times and dried to obtain 0.91 g of end-group aminated dextran (dextran-NH₂).
(ii) amidification: In a 25 mL round-bottom flask equipped with a magnetic stirrer were added dextran-NH₂ (0.40 g), Citropol-COOH (example 4, 0.80 g) and 6 mL of dried DMSO. After mixing, to this solution were added Novozyme 435 (0.15 g) and dried molecular sieve (1.00 g). The flask was sealed and the reaction mixture was stirred at 40° C. for 24 hours. After reaction, the modified dextran was precipitated three times into methanol to eliminate unreacted Citropol derivative. 0.32 g of dextran-block-Citropol amphiphilic polymer was recovered as a powder after drying process.

### (3) Emulsion Stability

### Example 9: Preparation of Cinmethylin Liquid Emulsion Comprising Dextran-Graft-Menthol

In a plastic vial were added 7.00 g of distilled water and 0.60 g of Dextran-graft-Menthol as produced in example 6. The medium was stirred to help the polymer dissolution. Then 2.40 g of Cinmethylin was added and the vial placed in an ice bath. The mixture was then subjected to high shear using a ultrasonic homogenizer UP400S (Hielscher Ultrasonics) for 1 min at an amplitude of 80% using 0.5 cycle. An homogeneous emulsion was obtained having a droplet diameter D[3,2]=2.8 μm. No phase separation or demixing was observed over 24 hours.

### Example 10

### Preparation of Cinmethylin Liquid Emulsion Comprising Dextran-Graft-Citropol

In a plastic vial were added 0.085 g Cinmethylin and 0.015 g of dextran-graft-citropol (as synthesized in example 7) and 9.90 g of phosphate buffer (pH 6 0.5 M). The mixture was finally blended for 5 min with a Ultraturax and a white emulsion was obtained.

No phase separation or change in turbidity was observed over 72 hours

### Example 11: Preparation of Cinmethylin Liquid Emulsion Comprising Hydrophilic Dextran (Comparative Example)

In a plastic vial were added 1 g Cinmethylin and 0.10 g of unmodified dextran 4 and 9.00 g of phosphate buffer (pH 5.8 0.5 M). The mixture was placed in an ice bad and was then subjected to high shear using a ultrasonic homogenizer Vibra Cell 72408 for 5 min at an amplitude of 30%. A stable emulsion was not possible to achieve and within hours a full demixing was found.

### (4) Herbicidal Activities of Cinmethylin Liquid Emulsions According to the Invention

The following cinmethylin liquid emulsions according the present invention, denoted herein as Formulations 1 and 2 (hereafter also denoted as F1 and F2) and having the compositions shown in Table 1, were evaluated for their herbicidal activity.

TABLE 1
Compositions of Formulations 1 and 2

| Ingredients | Formulation 1 | Formulation 2 |
|---|---|---|
| Cinmethylin | 30% by weight | 30% by weight |
| Dextran-graft-Menthol | 5.3% by weight | 10% by weight |
| Xanthan gum | 0.2% by weight | 0.2% by weight |
| water | 64.5% by weight | 59.8% by weight |

The Formulations 1 and 2 were prepared according to the procedure of Example 9 by using the amounts shown in Table 1. As a further exception, water was initially mixed not only with dextran graft menthol, but additionally with Xanthan gum in the amount indicated in Table 1.

The herbicidal activity of the Formulations 1 and 2 against various weeds as well as against crops was demonstrated by the following pre-emergence treatment greenhouse experiments. To this end, the Formulations 1 and 2 of the invention and conventional cinmethylin formulations were applied and the herbicidal effects of these treatments were compared.

The test plants were seeded in plastic containers in sandy loamy soil containing 5% of organic matter. For the pre-emergence treatment, in parallel the Formulations 1 and 2 and, for comparison purposes, two conventional formulations, namely a polyurea capsule suspension (CS) and an emulsifiable concentrate (EC) containing 400 g/l and 750 g/l of cinmethylin, respectively, were each applied directly after sowing by means of finely distributing nozzles at use rates of 100, 50, 25 and 12.5 g a.i./ha (a.i.=active ingredient; here cinmethylin). The containers were irrigated gently to promote germination and growth and subsequently covered with transparent plastic hoods until the plants had rooted. This cover caused uniform germination of the test plants, unless this was adversely affected by the active compounds. The plants were cultivated according to their individual requirements at 10 to 35° C.

The herbicidal activities of the individual herbicidal formulations were assessed 10 and 20 days after treatment (10 and 20 DAT). The results are summarized in Table 2. The evaluation for damage on undesired weeds and on crop plants caused by the formulations was carried out using a scale from 0 to 100%, compared to the untreated control plants. Here, 0% means no damage and 100% means complete destruction of the plants.

The plants used in the greenhouse tests belong to the following species:

| EPPO Code | Scientific name |
|---|---|
| ALOMY | Alopecurus myosuroides |
| LOLRI | Lolium rigidum |
| LOLMU | Lolium multiflorum |
| TRZAW* | Soft wheat (winter) |
| HORVW* | Barley (winter) |

*Crop plants (for testing the selectivity)

TABLE 2
Application in pre-emergence of the formulations F1 and F2 according
to the invention and of conventional CS and EC formulations:

| Weed/ | | Cinmethylin | observed herbicidal activity [%] | | | |
|---|---|---|---|---|---|---|
| Crop | DAT | [g ai/ha] | F1¹⁾ | F2¹⁾ | CS²⁾ | EC²⁾ |
| ALOMY | 10 | 100 | 95 | 98 | 95 | 98 |
| ALOMY | 10 | 50 | 98 | 98 | 90 | 95 |
| ALOMY | 10 | 25 | 90 | 95 | 80 | 95 |
| ALOMY | 10 | 12.5 | 90 | 85 | 55 | 85 |
| ALOMY | 20 | 100 | 95 | 98 | 95 | 98 |
| ALOMY | 20 | 50 | 98 | 98 | 90 | 95 |
| ALOMY | 20 | 25 | 90 | 90 | 85 | 95 |
| ALOMY | 20 | 12.5 | 85 | 80 | 40 | 85 |
| LOLRI | 10 | 100 | 95 | 95 | 95 | 95 |
| LOLRI | 10 | 50 | 95 | 95 | 65 | 95 |
| LOLRI | 10 | 25 | 80 | 90 | 45 | 80 |
| LOLRI | 10 | 12.5 | 60 | 75 | 10 | 65 |
| LOLRI | 20 | 100 | 95 | 98 | 98 | 95 |
| LOLRI | 20 | 50 | 90 | 85 | 65 | 90 |
| LOLRI | 20 | 25 | 65 | 75 | 35 | 70 |
| LOLRI | 20 | 12.5 | 50 | 60 | 10 | 45 |
| LOLMU | 10 | 100 | 95 | 95 | 85 | 95 |
| LOLMU | 10 | 50 | 90 | 95 | 65 | 95 |
| LOLMU | 10 | 25 | 85 | 75 | 40 | 85 |
| LOLMU | 10 | 12.5 | 55 | 60 | 20 | 70 |
| LOLMU | 20 | 100 | 90 | 98 | 80 | 95 |
| LOLMU | 20 | 50 | 85 | 90 | 60 | 95 |
| LOLMU | 20 | 25 | 75 | 70 | 35 | 80 |
| LOLMU | 20 | 12.5 | 50 | 60 | 10 | 65 |
| TRZAW | 10 | 100 | 0 | 0 | 0 | 0 |
| TRZAW | 10 | 50 | 0 | 0 | 0 | 0 |
| TRZAW | 10 | 25 | 0 | 0 | 0 | 0 |
| TRZAW | 10 | 12.5 | 0 | 0 | 0 | 0 |
| TRZAW | 20 | 100 | 0 | 0 | 0 | 0 |
| TRZAW | 20 | 50 | 0 | 0 | 0 | 0 |
| TRZAW | 20 | 25 | 0 | 0 | 0 | 0 |
| TRZAW | 20 | 12.5 | 0 | 0 | 0 | 0 |
| HORVW | 10 | 100 | 10 | 10 | 10 | 20 |
| HORVW | 10 | 50 | 10 | 10 | 0 | 10 |
| HORVW | 10 | 25 | 0 | 0 | 0 | 0 |
| HORVW | 10 | 12.5 | 0 | 0 | 0 | 0 |
| HORVW | 20 | 100 | 0 | 0 | 10 | 0 |
| HORVW | 20 | 50 | 0 | 0 | 0 | 0 |
| HORVW | 20 | 25 | 0 | 0 | 0 | 0 |
| HORVW | 20 | 12.5 | 0 | 0 | 0 | 0 |

¹⁾formulations F1 and F2 according to the invention
²⁾comparative CS and EC formulations

As can be seen from the results summarized in Table 2, the formulations F1 and F2 according to the invention exhibit increased or at least similar activities against weeds and also increased or at least similar selectivities for weeds over crops in comparison with conventional cinmethylin formulations.

1. A conjugate of a saccharide compound, selected from di-, oligo- and polysaccharides, and at least one hydrophobic compound selected from terpenes, polyterpenes and polyterpene ethers,
wherein the hydrophobic compound in the conjugate is either directly bound to an oxygen atom of the saccharide or is present as a radical of the formulae (I) or (II): 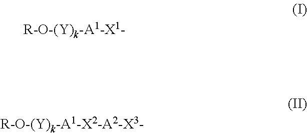
wherein in the formulae (I) and (II)
R is a radical of a terpene compound, a polyterpene or a polyterpene ether compound,
k is 0 or 1,
Y is C(O) or C(O)NH,
A¹ is a direct bond or C₁-C₆ alkylene,
A² is C₂-C₁₀ alkylene,
X¹ is C(O), or OC(O) or NHC(O) if k=1 and A¹ is C₁-C₆ alkylene and where X¹ is attached to an oxygen atom of the saccharide compound,
X² is C(O)NH or NHC(O)NH,
X³— is N═ or NH—,
and wherein X³ in formula (II) is attached to a carbon atom of the saccharide compound.

2. The conjugate of claim 1, wherein the saccharide compound of the conjugate has at least one of the following properties 2.a to 2.d:
2.a it has a number average of 2 to 1000 monosaccharide repeating units;
2.b it is a non-ionic polysaccharide;
2.c it is a glucan; or
2.d it is selected from dextrans, pullulans, dextrins and combinations thereof.

3. The conjugate of claim 1, wherein the hydrophobic compound is selected from mono-, sesqui- and diterpenols, oxidized mono-, sesqui- and diterpenols and polyterpene ether compounds, wherein the terpene units of the polyterpene ether compound is derived from mono-, sesqui- and diterpenols.

4. The conjugate of claim 3, wherein the hydrophobic compound is selected from monoterpenols, sesquiterpenols, oxidized monoterpenols and oxidized sesquiterpenols.

5. The conjugate of claim 3, wherein the hydrophobic compound is a terpenol which is selected from citronellol, nerol, geraniol, myrcenol, pulegol, menthol and combinations thereof.

6. The conjugate of claim 1, which has at least one of the following properties 5.a or 5.b:
5.a the weight ratio of the hydrophobic compound to the saccharide compound in the conjugate is in the range of 3:1 to 1:80; or
5.b the conjugate has a degree of substitution with the hydrophobic compound in the range of 1 to 300 mol-% with respect to the monosaccharide units of the saccharide.

7. The conjugate of claim 1, wherein the conjugate the hydrophobic compound is either directly bound to an oxygen atom of the saccharide or is present as a radical of the formulae (I).

8. The conjugate of claim 1, wherein the hydrophobic compound is present as a radical of the formulae (II), where R in the formulae (II) is in particular a polyterpene ether radical.

9. (canceled)

10. An aqueous composition, which is an aqueous emulsion of a water-immiscible liquid, which contains at least one conjugate as defined in claim 1.

11. The composition of claim 10, wherein the weight ratio of the conjugate to the water-immiscible liquid of the emulsion is in the range of 1:100 to 1:1.

12. The composition of claim 11, wherein the water-immiscible liquid comprises at least one organic active compound.

13. The composition of claim 12, wherein the at least one organic active compound is a water-immiscible liquid at 22° C. and/or dissolved in a water-immiscible organic solvent.

14. The composition of claim 12, wherein the at least one organic active compound is selected from agrochemicals, aromachemicals, pharmaceutically active compounds, vitamins, cosmetic actives and organic effect compounds.

15. The composition of claim 12, which is an oil-in-water (o/w) emulsion, where droplets of the o/w emulsion are formed by the water-immiscible liquid, which are surrounded by the at least one conjugate.

16. The composition of claim 10, wherein the relative amount of the conjugate is in the range of 1 to 50% by weight, based on the weight of the water immiscible liquid.

17. A method for stabilizing an aqueous emulsion of a water-immiscible liquid, comprising incorporating a conjugate as defined in claim 1 into the aqeuous emulsion of the water-immiscible liquid.

18. (canceled)

19. A method for controlling plant pathogenic organisms, comprising applying a pesticidally effective amount of a composition as claimed in claim 10 further comprising at least one agrochemical, onto the plant pathogenic organisms, or on the habitat of the plant pathogenic organisms, or to the plant whose growth shall be controlled.

20. The conjugate of claim 6, wherein the weight ratio of the hydrophobic compound to the saccharide compound in the conjugate is in the range of 2:1 to 1:60.

21. The composition of claim 10, wherein the weight ratio of the conjugate to the water-immiscible liquid of the emulsion is in the range of 1:50 to 1:2.

22. The composition of claim 10, wherein the weight ratio of the conjugate to the water-immiscible liquid of the emulsion is in the range of 1:30 to 1:3.
